(19) United States
(12) Patent Application Publication
(10) Pub. No.: US 2021/0256384 A1
(43) Pub. Date: Aug. 19, 2021

(54) COMPUTER-IMPLEMENTED METHODS AND SYSTEMS FOR ACHIEVING REAL-TIME DNN EXECUTION ON MOBILE DEVICES WITH PATTERN-BASED WEIGHT PRUNING

(71) Applicants: Northeastern University, Boston, MA (US); College of William & Mary, Williamsburg, VA (US)

(72) Inventors: Yanzhi Wang, Newton Highlands, MA (US); Xiaolong Ma, Boston, MA (US); Wei Niu, Jamestown, VA (US); Bin Ren, Jamestown, VA (US)

(21) Appl. No.: 17/176,464

(22) Filed: Feb. 16, 2021

Related U.S. Application Data
(60) Provisional application No. 62/976,595, filed on Feb. 14, 2020.

(51) Int. Cl. G06N 3/08; G06N 3/04

(52) U.S. Cl. CPC G06N 3/082; G06N 3/04

(57) ABSTRACT

PatDNN is an end-to-end framework to achieve real-time DNN execution on mobile devices. PatDNN includes two stages: a pattern-based pruning stage based on extended ADMM solution framework, and an optimized execution code generation stage including a high-level, fine-grained DNN layerwise representation and a set of architecture-aware optimizations. This design allows PatDNN to benefit from both high accuracy and hardware efficiency.

### CROSS REFERENCE TO RELATED APPLICATION

This application claims priority from U.S. Provisional Patent Application No. 62/976,595 filed on Feb. 14, 2020 entitled PATDNN: ACHIEVING REAL-TIME DNN EXECUTION ON MOBILE DEVICES WITH PATTERN-BASED WEIGHT PRUNING, which is hereby incorporated by reference.

### GOVERNMENT SUPPORT

This invention was made with government support under Grant No. 1739748 awarded by the National Science Foundation. The government has certain rights in the invention.

### BACKGROUND

The present application relates to methods and systems for achieving real-time deep neural network (DNN) execution on mobile devices with pattern-based weight pruning.

Deep learning or DNNs have become the fundamental element and core enabler of ubiquitous artificial intelligence. After obtaining DNN models trained with a huge amount of data, they can be deployed for inference, perception, and control tasks in various autonomous systems and internet-of-things (IoT) applications. Recently, along with the rapid emergence of high-end mobile devices, executing DNNs on mobile platforms gains popularity and is quickly becoming the mainstream [9, 28, 30, 43, 63] for broad applications such as sensor nodes, wireless access points, smartphones, wearable devices, video streaming, augmented reality, robotics, unmanned vehicles, smart health devices, etc. [2, 3, 29, 46, 50]. (Modern mobile platforms become increasingly sophisticated, usually equipped with both CPUs (central processing units) and GPUs (graphics processing units), e.g., Qualcomm Snapdragon 855 [47] has an octa-core Kryo 485 CPU and an Adreno 640 GPU.)

Considering the nature of these applications, achieving real-time DNN inference is an ideal but yet a very challenging goal for mobile devices due to the limited computing resources of embedded processors. For example, consider VGG-16 [52], one of the key DNN models in transfer learning with broad application scenarios. For an embedded GPU (Adreno 640, with 16-bit floating-point for weights/intermediate results), it takes 242 ms to perform inference using TVM [5], and is not even supported in TensorFlow-Lite (TFLite) [10]—these are two representative mobile-oriented, end-to-end DNN inference acceleration frameworks. It is clearly far from real-time execution.

To achieve the goal, it is necessary to consider algorithm-level innovations. To this end, DNN model compression techniques, including weight pruning [8, 12, 14, 15, 19, 42, 54] and weight/activation quantization [6, 7, 13, 22, 23, 35, 37, 45, 48, 56, 65], have been proposed and studied intensively for model storage reduction and computation acceleration. Early efforts on DNN model compression [8, 12, 14, 15, 19, 42, 54] mainly rely on iterative and heuristic methods, with limited and non-uniform model compression rates. Recently, a systematic DNN model compression framework (ADMM-NN) has been developed using the powerful mathematical optimization tool ADMM (Alternating Direction Methods of Multipliers) [4, 21, 39], currently achieving the best performance (in terms of model compression rate under the same accuracy) on weight pruning [49, 64] and one of the best on weight quantization [35].

Despite the high compression ratio, there is a significant gap between algorithm-level innovations and hardware-level performance optimizations for DNN inference acceleration. Specifically, the general but non-structured weight pruning (i.e., arbitrary weight can be pruned) [12, 15] can seriously affect processing throughput because the indices for the compressed weight representation prevent achieving high parallelism [19, 42, 54]. While ADMM-NN achieves higher and more reliable compression ratios, hardware implementation obstacle due to the non-structured nature still stays the same. Alternatively, the structured pruning [19, 42, 54], e.g., filter and channel pruning, can generate more hardware-friendly models but result in relatively higher accuracy drop. To achieve the real-time inference for representative DNNs in mobile devices, it is desirable to develop an end-to-end DNN acceleration framework that achieves both high accuracy and high hardware efficiency.

The general non-structured pruning and current structured pruning represent two extremes in the design space. In non-structured pruning, any weight can be pruned, while in structured pruning, the pruning is done for the whole filter or channel. Thus, non-structured pruning is completely fine-grained, which achieves high compression ratio but is not hardware or software optimization friendly, while structured pruning is coarse-grained, which generates hardware-efficient regular models with higher accuracy loss.

In accordance with various embodiments, the state-of-the-art is advanced by naturally introducing a new dimension, fine-grained pruning patterns inside the coarse-grained structures, revealing a previously unknown point in design space. This new dimension allows more flexible exploration of the trade-off between accuracy and hardware efficiency. In this paradigm, the key question is how to “recover” the hardware efficiency lost due to the fine-grained patterns. The unique insight of our solution is to use the compiler to seamlessly close the gap between hardware efficiency of fully structured pruning and the pattern-based “semi-structured” pruning.

Specifically, we propose PatDNN, a novel end-to-end mobile DNN acceleration framework that can generate highly accurate DNN models using pattern-based pruning methods and guarantee execution efficiency with compiler optimizations. PatDNN consists of two stages: (1) pattern-based training stage, which performs kernel pattern and connectivity pruning (termed pattern-based pruning in general) with a pattern set generation and an extended ADMM solution framework, and (2) execution code generation stage, which converts DNN models into computational graphs and applies multiple optimizations including: a high-level and fine-grained DNN layerwise representation, filter kernel reorder, load redundancy eliminations, and automatic parameter tuning. All design optimizations are general, and applicable to both mobile CPUs and GPUs.

Various embodiments disclosed herein include the following contributions:

First, a novel pattern-based DNN pruning approach is disclosed that achieves the benefits of both non-structured and structured pruning while avoiding their weaknesses.

Second, it enhances the recent ADMM-NN framework [49, 61] with pattern selection capability to map a pattern to each kernel, and train non-zero weights.

Third, it identifies the compatibility of the proposed pattern-based pruning scheme with compiler code generation, and develop multiple novel compiler optimizations for compressed DNN execution. These optimization opportunities are enabled only by our pattern-based design, and do not exist in any prior DNN execution frameworks.

Fourth, it implements an end-to-end DNN acceleration framework PatDNN on mobile platforms, compatible with modern embedded CPU and GPU architectures, achieving real-time performance on representative DNNs without accuracy loss.

We compare PatDNN with three state-of-the-art end-to-end DNN frameworks on both mobile CPU and GPU, TensorFlow Lite [10], TVM [5], and Alibaba Mobile Neural Networks [1] using three widely used DNNs, VGG-16, ResNet-50, and MobileNet-V2 and two benchmark datasets, ImageNet and CIFAR-10. Our evaluation results show that PatDNN achieves up to 44.5× speedup without any accuracy compromise. Using Adreno 640 embedded GPU, PatDNN achieves 18.9 ms inference time of VGG-16 on ImageNet dataset. To the best of our knowledge, it is the first time to achieve real-time execution of such representative large-scale DNNs on mobile devices.

### BRIEF SUMMARY OF THE DISCLOSURE

A computer-implemented method in accordance with one or more embodiments is provided for compressing a deep neural network (DNN) model by DNN weight pruning and accelerating DNN execution in a mobile device to achieve real-time inference. The method includes the steps of: (a) performing an intra-convolution kernel pruning of the DNN model wherein a fixed number of weights are pruned in each convolution kernel of the DNN model to generate sparse convolution patterns; (b) performing inter-convolution kernel pruning of the DNN model to generate connectivity sparsity, wherein inter-convolution kernel pruning comprises cutting connections between given input and output channels of the DNN model to remove corresponding kernels; (c) training the DNN model compressed in steps (a) and (b); and (d) applying a compiler-assisted DNN acceleration framework to the DNN model trained in (c) to generate code to be executed on the mobile device.

A computer system in accordance with one or more embodiments includes at least one processor, memory associated with the at least one processor, and a program supported in the memory for compressing a deep neural network (DNN) model by DNN weight pruning and accelerating DNN execution in a mobile device to achieve real-time inference. The program contains a plurality of instructions which, when executed by the at least one processor, cause the at least one processor to: (a) perform an intra-convolution kernel pruning of the DNN model wherein a fixed number of weights are pruned in each convolution kernel of the DNN model to generate sparse convolution patterns; (b) perform inter-convolution kernel pruning of the DNN model to generate connectivity sparsity, wherein inter-convolution kernel pruning comprises cutting connections between given input and output channels of the DNN model to remove corresponding kernels; (c) train the DNN model compressed in (a) and (b); and (d) apply a compiler-assisted DNN acceleration framework to the DNN model trained in (c) to generate code to be executed on the mobile device.

### BRIEF DESCRIPTION OF THE DRAWINGS

FIG. 1 is a simplified diagram illustrating an exemplary DNN CONV layer computation.

FIG. 2 is a simplified diagram illustrating (a) non-structured weight pruning and (b) two types of structured weight pruning.

FIG. 3 is a simplified diagram illustrating (a) kernel pattern pruning on CONV kernels and (b) connectivity pruning by removing kernels in accordance with one or more embodiments.

FIG. 4 is a simplified diagram illustrating connectivity pruning in accordance with one or more embodiments.

FIG. 5 is a simplified diagram illustrating a PatDNN acceleration framework in accordance with one or more embodiments.

FIG. 6 is a simplified diagram showing an algorithm-level overview of PatDNN training in accordance with one or more embodiments.

FIG. 7 is a simplified diagram illustrating an exemplary PatDNN compiler-based optimization and code generation flow in accordance with one or more embodiments. The compiler takes both model codes with graph-based optimizations and a layerwise representation (shown as an example in FIG. 8) to generate low-level C/C++ and OpenCL codes (as No-opt). This low-level code is further optimized with a filter kernel reorder and FKW compact model storage (+Reorder), the register-level load redundancy elimination (+LRE), and other optimizations like auto-tuning. The code is then deployed on mobile devices.

FIG. 8 shows an example of an LR for a CONV layer.

FIG. 9 is a simplified diagram illustrating an example of a filter kernel reorder optimization in accordance with one or more embodiments.

FIG. 10 is a simplified diagram illustrating an example of FKW compressed weight storage in accordance with one or more embodiments.

FIG. 11 is a simplified diagram illustrating load redundancy elimination at a kernel-level and a filter-level in accordance with one or more embodiments.

FIGS. 12A-12D are graphs illustrating overall performance for differently trained DNN models in terms of average DNN inference execution time in accordance with one or more embodiments.

FIGS. 13A and 13B are graphs showing speedup rates using optimization and no-optimization on each unique CONV layer in accordance with one or more embodiments.

FIGS. 14A and 14B are graphs showing profiling results of reorder and redundancy elimination in accordance with one or more embodiments.

FIGS. 15A and 15B are graphs showing the effect of different loop permutations and loop tiling in accordance with one or more embodiments.

FIG. 16 is a graph showing extra data structure overhead: FKW over CSR on unique VGG CONV layers with different pruning rates in accordance with one or more embodiments.

FIGS. 17A and 17B are graphs showing a GFLOPS performance study: PatDNN vs dense in accordance with one or more embodiments.

FIGS. 18A and 18B are graphs showing a portability study: performance on two other platforms in accordance with one or more embodiments.

FIGS. 19-25 show Tables 1-7, respectively.

FIG. 26 is a block diagram illustrating an exemplary computer system in which the methods described herein in accordance with one or more embodiments can be implemented.

### DETAILED DESCRIPTION

Layerwise Computation of DNNs

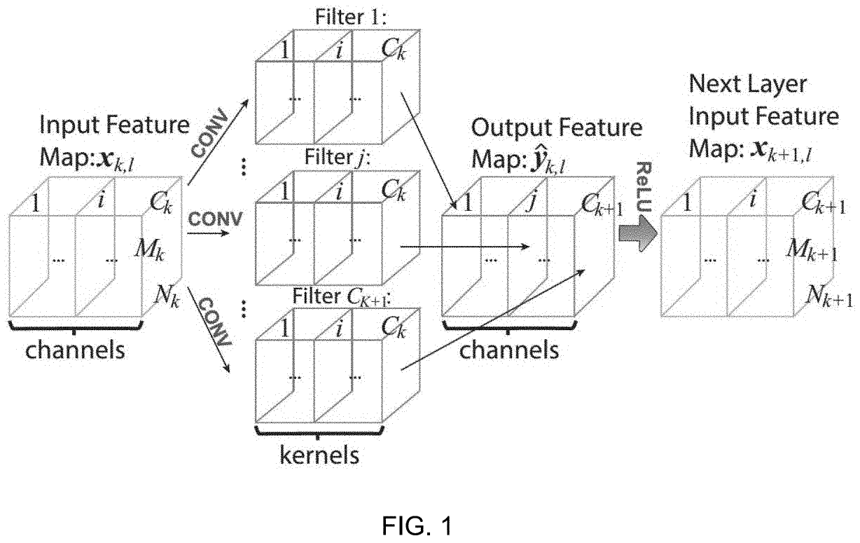

DNN models can be viewed as cascaded connections of multiple functional layers such as convolutional (CONV), fully-connected (FC), and pooling (POOL) layers to extract features for classification or detection [26, 34, 62]. Take the most computation-intensive CONV layer as an example, as shown in FIG. 1, the input feature map of the k-th layer has a size of Mk××Nk×Ck, where Ck is the number of channels of the input feature map. This layer uses Ck+1 CONV filters, each with a size of Pk×Qk×Ck. Note that the number of kernels Ck in a CONV filter should match the number of channels Ck in the input feature map to perform convolution. Each j-th CONV filter performs convolution with the input feature map, using a stride of Sk, resulting in the j-th channel in the output feature map. Therefore, the number of channels in the output feature map equals to the number of filters Ck+1, while the size of the output feature map i.e., Mk+1 and Nk+1 is determined by Mk, Nk, Pk, Qk, and Sk. The CONV layer is followed by an activation layer, which performs an activation operation, typically ReLU, on the output feature map. Besides the functional layers in DNNs, batch normalization becomes an essential operation to increase the stability of DNN training by overcoming the gradient vanishing issue [25].

Mobile Acceleration of DNNs

In recent years, there have been intensive efforts on DNN inference acceleration frameworks targeting mobile devices, include DeepX [28], TFLite [10], DeepEar [31], TVM [5], Alibaba Mobile Neural Network (MNN) [1], DeepCache [57], DeepMon [24], DeepSense [60], and MCDNN [16]. Most of these prior works do not fully utilize model compression techniques. Other efforts that explore model sparsity and model compression to accelerate the DNN execution include Liu et al. [38], DeftNN [20], SCNN [44], AdaDeep [40]. However, they either do not target mobile platforms, or require new hardware, or trade off compression rate and accuracy, introducing various drawbacks compared to our work.

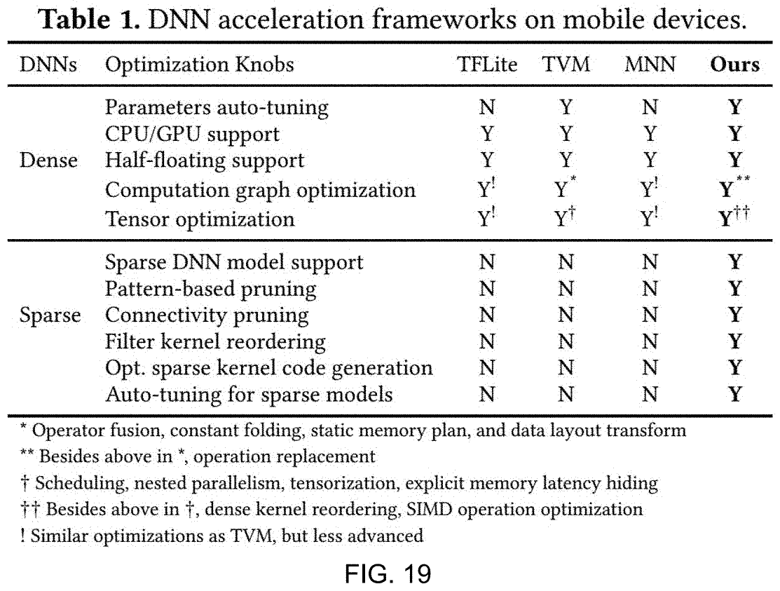

Table 1 (FIG. 19) compares the major optimization techniques offered by three state-of-the-art, end-to-end DNN inference frameworks (TFLite [10], TVM [5], and MNN [1]). We do not include other efforts, e.g., DeepCache [57] and DeepMon [24], since they mainly focus on specific DNN applications rather than general DNNs. One goal herein is to find the most appropriate weight pruning scheme for mobile DNN acceleration and the corresponding full-stack acceleration framework. We utilize 16-bit floating point representation on GPU for both weights and intermediate results, which are supported in mobile devices and shown to incur no accuracy loss [1, 5, 10] for DNNs.

DNN Model Compression and Challenges

DNN model compression has been proposed for simultaneously reducing the storage/computation and accelerating inference with minor classification accuracy (or prediction quality) loss. Model compression is performed during DNN training. Two important categories of DNN model compression techniques are weight pruning [8, 12, 15, 19, 42, 54] and weight quantization [6, 22, 35, 37, 45, 48, 56, 65].

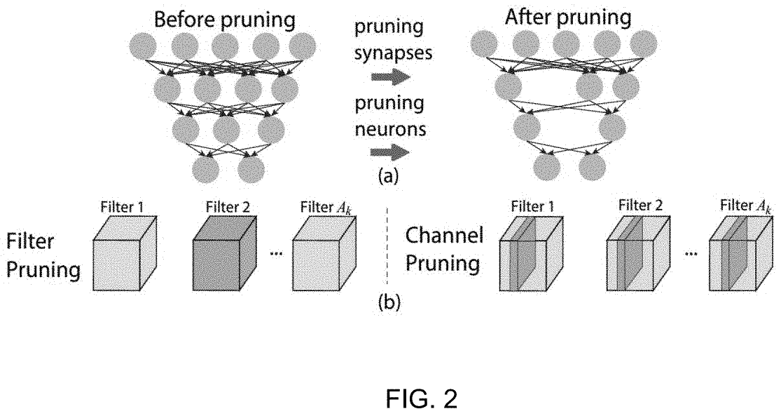

Weight pruning reduces the redundancy in the number of weights. As shown in FIG. 2, two main approaches of weight pruning are (1) the general and non-structured pruning; and (2) structured pruning, which produces irregular and regular compressed DNN models.

Non-Structured Pruning: In this method, arbitrary weights can be pruned. It can result in a high pruning rate, i.e., reduction in the number of weights, which can reduce the actual computation. For compiler and code optimization, non-structured pruning incurs several challenges due to the irregularity in computation and memory access. First, the irregular and sparse kernel weights require heavy control-flow instructions, which degrade instruction-level parallelism. Second, it introduces thread divergence and load imbalance due to the fact that kernels in different filters have divergent workloads and they are usually processed by multiple threads, a key concern for efficient thread-level parallelism. Third, it usually incurs low memory performance due to poor data locality and cache performance. More importantly, it prohibits advanced memory optimizations such as eliminating redundant loads that widely exist in convolution operations. Similarly, for hardware acceleration, since the pruned models are stored in some sparse matrix format with indices, they often lead to performance degradation in GPU and CPU implementations [8, 12, 15].

Structured Pruning: This method can produce regular, but smaller weight matrices. The lower part of FIG. 2 illustrates the representative structured pruning schemes: filter pruning and channel pruning [54]. Filter and channel pruning can be considered as equivalent in that pruning a filter in the k-th layer is equivalent to pruning the corresponding channel in the (k+1)-th layer. Filter/channel pruning is compatible with Winograd algorithm [32, 55] that has been used to accelerate computation of the original DNNs. Due to the regular structure, the GPU/CPU implementations typically lead to more significant acceleration [19, 42, 54]. However, the structured pruning suffers from notable accuracy loss [19, 54].

ADMM-based DNN Model Compression Framework

Recent work ADMM-NN [49, 61] leverages Alternating Direction Methods of Multipliers (ADMM) method for joint DNN weight pruning and quantization. ADMM is a powerful tool for optimization, by decomposing an original problem into two subproblems that can be solved separately and efficiently. For example, considering optimization problem minx f(x)+g(x). In ADMM, this problem is decomposed into two subproblems on x and z (auxiliary variable), which will be solved iteratively until convergence. The first sub-problem derives x given z: minx f (x)+q1(x|z). The second subproblem derives z given x: minz g(z)+q2(z|x). Both q1 and q2 are quadratic functions.

As a unique property, ADMM can effectively deal with a subset of combinatorial constraints and yield optimal (or at least high quality) solutions [21, 39]. Luckily, the necessary constraints in the DNN weight pruning and quantization belong to this subset of combinatorial constraints, making ADMM applicable to DNN model compression.

Due to the unprecedented results on accuracy and pruning rate, ADMM-NN [49] is considered as the state-of-art results for non-structured weight pruning and one of state-of-art methods for weight quantization. For non-structured pruning, ADMM-NN achieves 167×, 24×, and 7× weight reductions on LeNet-5, AlexNet, and ResNet-50 models, respectively, without accuracy loss. However, the framework only focuses on non-structured weight pruning, in which the pruning rate does not directly translate to performance improvements.

ADMM-NN can be extended to perform structured pruning, i.e., filter/channel pruning, and our results show that it leads to 1.0% Top-5 accuracy degradation with 3.8× weight reduction on VGG-16 CONV layers using ImageNet dataset. Although better than prior work (1.7% in [19] and 1.4% in AMC [18]), this accuracy loss is not negligible for many applications.

Based on the discussion of prior work on weight pruning, we rethink the design space and observe that non-structured and structured pruning represent two extremes in the design space. In non-structured pruning, any weight can be pruned, we consider it as a fine-grained method; in structured pruning, the weights of whole filter or channel are pruned together; we consider it as a coarse-grained method. Correspondingly, the two methods have different implications on hardware acceleration and software optimization: non-structured pruning is not hardware or software optimization friendly, so the higher pruning ratio cannot fully translate to performance gain, while structured pruning incurs higher accuracy loss.

The motivation of our study is to seek an approach that can offer the best of both methods. To achieve that, we naturally introduce a new dimension, fine-grained pruning patterns inside the coarse-grained structures, revealing a previously unknown point in design space. With the higher accuracy enabled by fine-grained pruning pattern, the key question is how to regain similar hardware efficiency as coarse-gained structured pruning. We take a unique approach and leverage compiler optimizations to close the performance gap between full structured pruning and pattern-based “semi-structured” pruning.

### Overview of PatDNN

Pattern-based Pruning

In pattern-based pruning, the key consideration is how to design and select the patterns. To achieve high accuracy and execution efficiency, we need to design the patterns considering the implication for theory and algorithm, compiler optimization, and hardware execution. Good patterns should have two key properties: flexibility and regularity.

Flexibility is not only desirable at theory and algorithm level but also enables efficient compiler code generation. Specifically, it allows compilers to maximize or maintain both instruction-level and thread-level parallelism. The regularity not only results in highly efficient hardware execution but also enables efficient compiler optimizations such as redundant load elimination to further improve performance. Compared to irregular structures, recent works also show from theory and algorithm level that high accuracy or function approximation capability can be achieved at the same time with certain regularity. Given these two key properties, we propose two pattern-based pruning techniques: kernel pattern pruning and connectivity pruning.

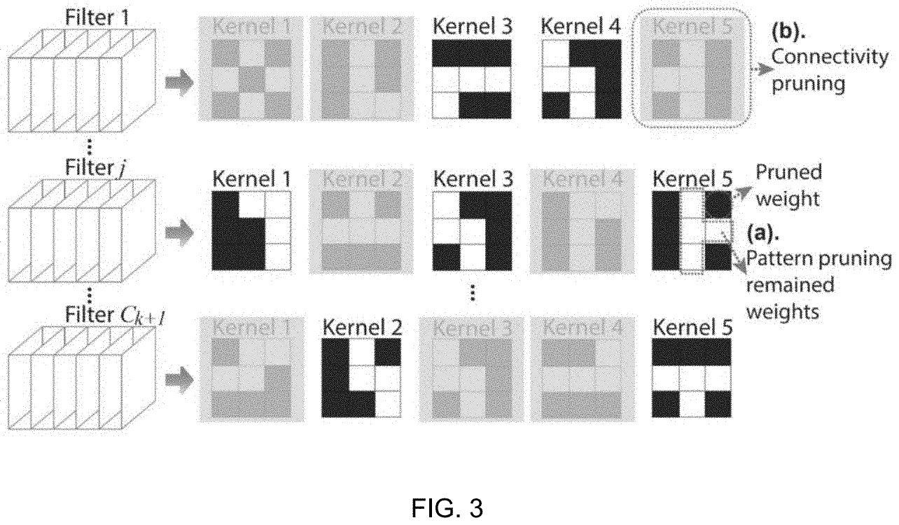

Kernel Pattern Pruning is illustrated in FIG. 3. For each kernel (in a CONV filter), a fixed number of weights are pruned, and the remaining weights (white cells) form specific “kernel patterns”. We define the example in FIG. 3 as 4-entry pattern pruning, since every kernel reserves 4 non-zero weights out of the original 3×3 kernel (the most commonly used kernel). The same approach is also applicable to other kernel sizes and the FC layer. For each kernel, it possesses flexibility in choosing among a number of pre-defined patterns.

At theory and algorithm level, it is shown in [33, 36] that the desirable kernel shape has certain patterns to match the connection structure in human visual systems, instead of a square shape. The selection of an appropriate pattern for each kernel can be naturally done by extending ADMM-based framework. As discussed below, we achieve accuracy enhancement in all representative DNNs in our testing. At the compiler level, the pre-defined pattern allows the compiler to reorder and generate codes at filter and kernel levels so that kernels with the same pattern can be grouped for consecutive executions to maximize instruction-level parallelism. At hardware level, the 4-entry patterns are extremely friendly to the SIMD architecture in embedded processors based on either GPUs or CPUs. Note that our approach is general and can be applied to any pre-defined patterns, not just the 4-entry pattern shown in the figure.

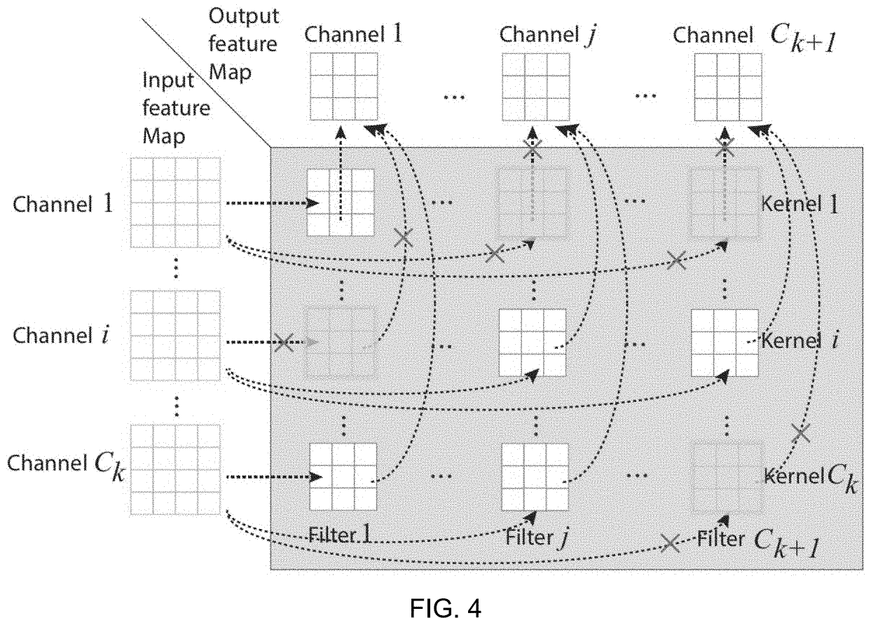

Connectivity Pruning is illustrated in FIG. 4. The key insight is to cut the connections between certain input and output channels, which is equivalent to removal of corresponding kernels. In CONV layers, the correlation between input channel i and output channel j is represented by the i-th kernel of filter j. This method is proposed for overcoming the limited weight pruning rate by kernel pattern pruning.

At theory and algorithm levels, the connectivity pruning matches the desirability of locality in layerwise computations inspired by human visual systems [58, 59]. It is more flexible than the prior filter/channel pruning schemes that remove whole filters/channels, thereby achieving higher accuracy. At the compiler and hardware level, removed kernels and associated computations can be grouped by compiler using the re-ordering capability without affecting the other computations, thereby maintaining parallelism degree.

Overview of PatDNN Acceleration Framework

Based on the above discussions, we propose “PatDNN” in accordance with one or more embodiments, a novel end-to-end mobile DNN acceleration framework that can generate highly accurate DNN models using pattern-based pruning methods and guarantee execution efficiency with compiler optimizations. Compared to recent prior works [18, 19, 49, 54], PatDNN uniquely enables cross-layer vertical integration, making it desirable across theory/algorithm, compiler and hardware. Allowing compilers to treat pruned kernels as special patterns, our approach not only achieves high pruning rate with high accuracy, but also effectively converts into performance improvements due to hardware friendly properties.

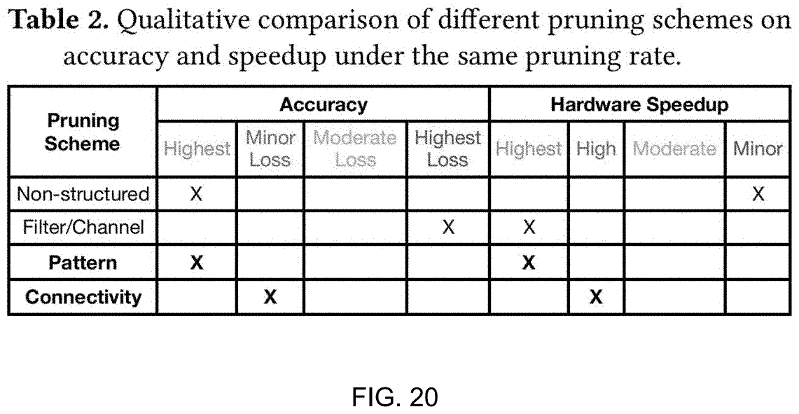

As shown in Table 2 (FIG. 20), PatDNN can achieve the benefits of both non-structured and structured pruning. The key enabler to achieving this goal is to leverage compiler to maintain the efficiency of structured pruning based on kernel pattern and connectivity pruning. Our approach is an excellent example of hardware and software co-design, which can be compared to an intuitive analogy: the multi-level cache memory hierarchy provides sufficient hardware supports to hide memory access latency and explore locality, but compiler and software optimizations are still needed to fully realize effective cache management policy.

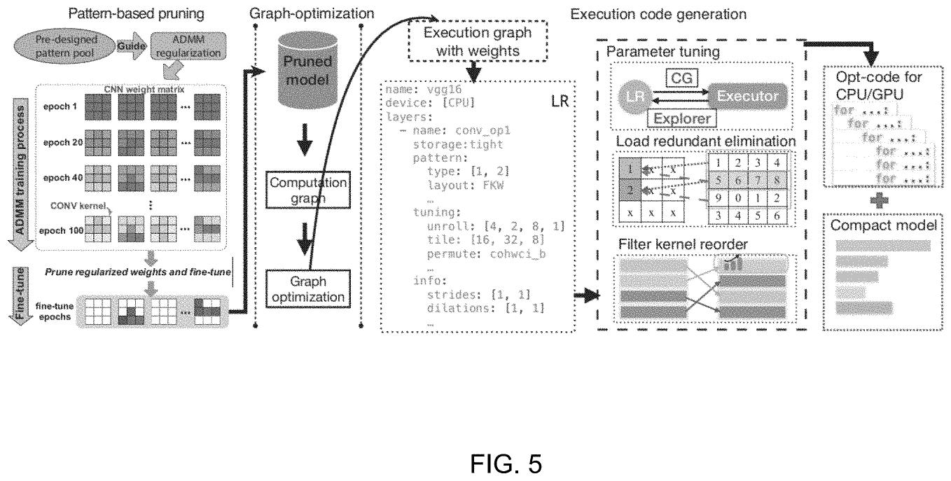

FIG. 5 shows an overview of PatDNN in accordance with one or more embodiments. It includes two stages: (1) pattern-based training stage (discussed above), which performs kernel pattern and connectivity pruning with an extended ADMM solution framework. (2) execution code generation stage (discussed above), which performs multiple effective optimizations based on the patterns. Similar to TVM [5], PatDNN converts DNN models into computational graphs and applies multiple graph-based optimizations. Based on these optimizations, we focus on layerwise design and optimization including a high-level and fine-grained DNN layerwise representation (LR), filter kernel reorder, load redundancy eliminations, and automatic parameter tuning. All of these designs and optimizations are general, and applicable to both mobile CPUs and GPUs. The second stage generates optimized execution codes as well as DNN models with weights stored in a novel compact format.

PatDNN Training with Pattern-based Pruning

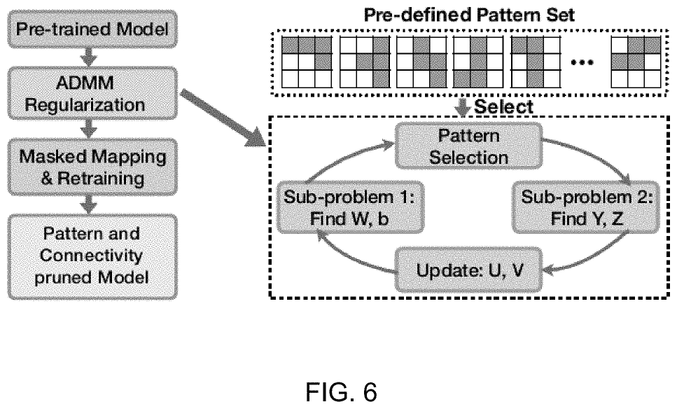

This section describes the methods to generate compressed DNN models for PatDNN. The procedure is composed of two steps: (1) we design a set of desired patterns to be selected for each kernel; (2) assign a pattern for each kernel (kernel pattern pruning) or prune the whole kernel (connectivity pruning), and train the pattern-based weights for maintaining accuracy. The overall flow is shown in FIG. 6. Essentially, it reflects the algorithm aspects of PatDNN. Our method can be applied to either a pre-trained DNN or train a model from scratch.

Designing the Pattern Set

We need to determine the number of patterns, and design each specific candidate pattern in the pattern set. The number of patterns is an important hyperparameter that should be carefully considered. If it is too large, it is more challenging to generate efficient codes, thereby affecting performance; if it is too small, the lack of flexibility may lead to accuracy degradation. Through empirical study, we validate that 6-8 patterns in the set achieves as a desirable tradeoff for the most common 3×3 kernel—ensuring low compiler overhead while maintaining high accuracy.

When the number of patterns is determined and 4-entry patterns are utilized, the compiler optimization and hard-ware efficiency are oblivious to the specific pattern shapes. However, the specific patterns to use need to be carefully optimized to maintain high accuracy after kernel pattern pruning. The key insights of pattern design are: (1) both theory and empirical studies [58, 59] show that the central weight in a 3×3 kernel is critical and shall not be pruned; and (2) it is desirable that the distortion is small for each kernel before and after kernel pattern pruning. Hence, we propose the following heuristic. First, for the pre-trained DNN, we scan all the kernels, and for each kernel, we find the four weights with largest magnitudes (including the central weight). These four weights form a 4-entry pattern, called the natural pattern of the kernel. According to the definition of natural patterns, there are a total of (⁸₃)=56 number of possible patterns. Suppose we aim at k different patterns in the candidate set. We count and select the Top-k most commonly appeared natural patterns across all kernels in the DNN, thereby forming the pattern candidate set (to select from in the subsequent step).

Our study on pattern number and pattern style selection is consistent with the pattern pruning theory work that is proposed in [41]. Different from pattern theory derivation in [41], our approach focuses on system-level design and compiler optimization of the pattern-based acceleration framework.

Kernel Pattern and Connectivity Pruning Algorithm

Problem Formulation: Consider an N-layer DNN, and we focus on the most computationally intensive CONV layers. The weights and biases of layer k are respectively denoted by Wk and bk, and the loss function of DNN is denoted by

f({Wₖ}ₖ₌₁^{N},{bₖ}ₖ₌₁^{N}),

refer to [64] for more details. In our k=1 discussion,

{Wₖ}ₖ₌₁^{N} and {bₖ}ₖ₌₁^{N}

respectively characterize the collection of weights and biases from layer 1 to layer N. Then the pattern and connectivity pruning is formulated as an optimization problem:

$${minimize}_{\{ {W}_{k} \} , \{ {b}_{k} \}} f ( {\{ {W}_{k} \}}_{k = 1}^{N} , {\{ {b}_{k} \}}_{k = 1}^{N} ) , \\ subject to {W}_{k} ∈ {𝒮}_{k} , {W}_{k} ∈ {𝒮}_{k}^{′} , k = 1 , … , N . \qquad ( 1 )$$

The collection of weights in the k-th CONV layer forms a four-dimensional tensor, i.e., Wk∈R^{Pk×Qk×Ck×Ck+1} where Pk, Qk,Ck, and Ck+1 are respectively the height of kernel, the width of kernel, the number of kernels, and the number of filters, in layer k. Suppose X denotes the weight tensor in a specific layer, then (X)_{:,:,a,b} denotes a specific kernel.

In kernel pattern pruning, the constraint in the k-th CONV layer is Wk∈Sk:={X|each kernel in X needs to satisfy one specific pattern shape in the pattern set (and non-zero weight values can be arbitrary)}. In connectivity pruning, the constraint in the k-th CONV layer is Wk∈Sk′:={X|the number of nonzero kernels in X is less than or equal to αk} (αk is a predetermined hyperparameter with more discussions later). Both constraints need to be simultaneously satisfied.

Extended ADMM-based Solution Framework: The constraint Wk∈Sk in problem (1) is different from the clustering-like constraints in ADMM-NN [49], in that it is flexible to select a pattern for each kernel from the pattern set. As long as a pattern is assigned for each kernel, constraints in problem (1) become clustering-like and ADMM compatible. Similar to ADMM-NN [49], the ADMM-based solution is an iterative process, starting from a pre-trained DNN model. We assign an appropriate pattern for each kernel based on the L2-norm metric in each iteration, to achieve higher flexibility.

By incorporating auxiliary variables Zk's and Yk's, and dual variables Uk's and Vk's, we decompose (1) into three subproblems, and iteratively solve until convergence. In iteration 1, after assigning patterns we solve the first subproblem

$${minimize}_{\{ {W}_{k} \} , \{ {b}_{k} \}} f ( {\{ {W}_{k} \}}_{k = 1}^{N} , {\{ {b}_{k} \}}_{k = 1}^{N} ) + {\sum }_{k = 1}^{N} \frac{{ρ}_{k}}{2} {‖ {W}_{k} - {Z}_{k}^{l} + {U}_{k}^{l} ‖}_{F}^{2} + {\sum }_{k = 1}^{N} \frac{{ρ}_{k}}{2} {‖ {W}_{k} - {Y}_{k}^{l} + {V}_{k}^{l} ‖}_{F}^{2} . \qquad ( 2 )$$

The first term is the loss function of the DNN, while the other quadratic terms are convex. As a result, this subproblem can be solved by stochastic gradient descent (e.g., the ADAM algorithm [27]) similar to training the original DNN.

The solution {Wk} of subproblem 1 is denoted by {W^{l+1}ₖ}. Then we aim to derive {Z^{l+1}ₖ} and {Y^{l+1}ₖ} in subproblems 2 and 3. These subproblems have the same form as those in ADMM-NN [49]. Thanks to the characteristics in combinatorial constraints, the optimal, analytical solution of the two subproblems are Euclidean projections, and are polynomial time solvable. For example, for connectivity pruning, the projection is: keeping αk kernels with largest L2 norms and setting the rest of kernels to zero. For kernel pattern pruning it is similar. Finally, we update dual variables Uk and Vk according to the ADMM rule [4] and thereby complete the 1-th iteration in the ADMM-based solution.

The hyperparameter determination process is relatively straightforward for joint pattern and connectivity pruning. There is no additional hyperparameters for kernel pattern pruning when the pattern set has been developed. For connectivity pruning we need to determine the pruning rate αk for each layer. In this paper, we adopt a heuristic method of uniform pruning rate for all layers except for the first layer (which is smaller, yet more sensitive to pruning).

Accuracy Validation and Analysis

We validate the accuracy of ADMM-based joint kernel pattern and connectivity pruning, based on ImageNet ILSVRC-2012 and CIFAR-10 datasets, using VGG-16 [52], ResNet-50 [17], and MobileNet-V2 [51] DNN models. Our implementations are based on PyTorch, and the baseline accuracy results are in many cases higher than prior work, which reflects the recent progress in DNN training. With a pre-trained DNN model, we limit the number of epochs in kernel pattern and connectivity pruning to 120, similar to the original DNN training in PyTorch and much lower than iterative pruning [15].

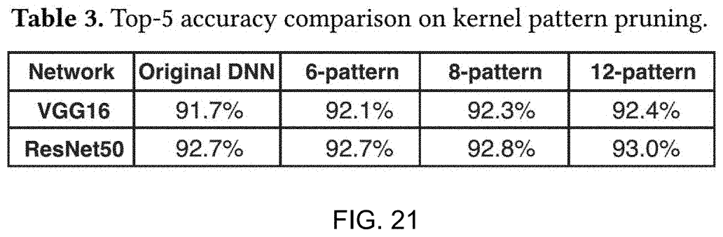

Table 3 (FIG. 21) illustrates the Top-5 accuracy comparison on kernel pattern pruning only, applied on the CONV layers of VGG-16 and ResNet-50 using ImageNet dataset. The baseline is the original DNN without patterns, and we demonstrate the accuracy results with 6, 8, and 12 patterns (all 4-entry patterns) in the pattern set. Our first observation is that the accuracy will improve when the number of candidate patterns is sufficient—typically 4-8 patterns are sufficient. This is attributed to the compatibility of kernel pattern pruning with human visual system and the ability to eliminate overfitting (compared with square kernel shape). This observation has been also validated for other types of DNNs and data sets (e.g., CIFAR-10).

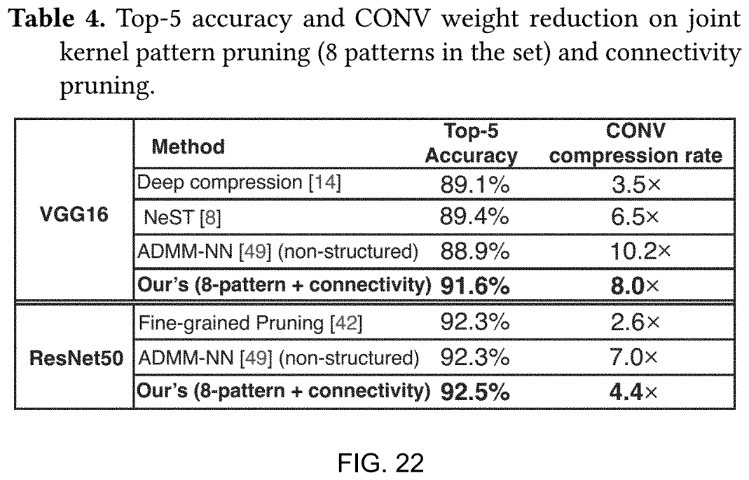

Table 4 (FIG. 22) illustrates the Top-5 accuracy comparison on joint kernel pattern pruning (8 patterns in the set) and connectivity pruning, on VGG-16 and ResNet-50 using ImageNet dataset. For VGG-16, all kernels are 3×3. After applying 4-entry patterns on all kernels and 3.6× uniform connectivity pruning, we achieve around 8× weight reduction on CONV layers of VGG-16. For ResNet-50, a portion of kernels are 1×1 besides the majority of 3×3 kernels. We apply kernel pattern pruning on all 3×3 ones, and apply uniform 3.6× connectivity pruning on all kernels. We achieve 4.4× weight reduction on CONV layers. One can observe from the table that (1) no Top-5 accuracy drop with this setup; (2) under the same accuracy, the weight reduction rate is close to ADMM-based (and outperforms prior heuristic based) non-structured pruning on CONV layers.

For the CIFAR-10 dataset, we observe consistent accuracy improvements with 8 patterns on 3×3 kernels and 3.6× connectivity pruning, with results shown b.

PatDNN Inference Code Optimization

For DNN models with kernel pattern and connectivity pruning, PatDNN ensures hardware execution efficiency of DNN inference with optimized compiler and code generation. As aforementioned, compiler optimizations play the key role in “recovering” the performance loss due to the fine-grained pattern-based pruning compared to fully structured pruning. This stage includes two-levels of optimizations: (1) optimizations on computational graphs that explore the potential opportunities among multiple DNN layers; and (2) optimizations within each layer. PatDNN adopts an enhanced TVM [5]-like approach together with other innovations from the latest efforts in this direction (e.g., Tensor Comprehensions [53]) to implement the former (with major optimizations summarized in Table 1). Due to space limit, we do not elaborate each as they are not the main research contribution and not specific to DNN execution optimization leveraging pattern-based pruning.

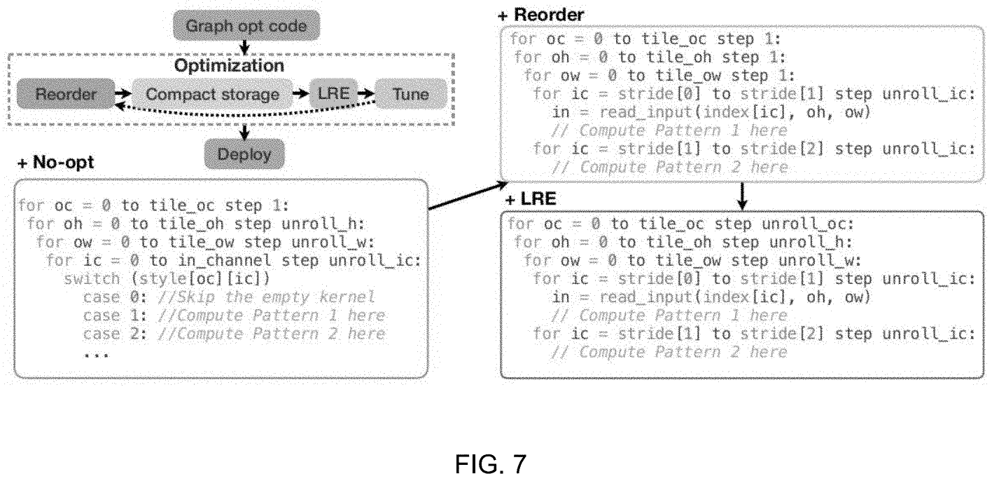

This section focuses on PatDNN's layerwise optimizations based on kernel pattern and connectivity pruning that are specifically designed to address the challenges in DNN acceleration with non-structured weight pruning, i.e., heavy control-flow instructions, thread divergence and load imbalance, and poor memory performance. These optimizations are general, and applicable to both mobile CPUs and GPUs. Our framework can generate both optimized CPU (vectorized C++) code and GPU (OpenCL) code. FIG. 7 illustrates PatDNN's compiler-based optimization and code generation flow with a CONV layer example.

Compiler-based PatDNN Inference Framework

Layerwise Representation: A key feature of PatDNN is its sparsity- and pruning-aware design. To support it, PatDNN provides a high-level fine-grained Layerwise Representation (LR) to capture the sparsity information. This LR includes intensive DNN layer specific information to enable aggressive layerwise optimizations. In particular, it includes detailed kernel pattern and connectivity-related information (e.g., the pattern types presented in this layer, the pattern order in each filter, the connection between kernels and input/output channels, etc.); and tuning-decided parameters (e.g., the input and output tile sizes, unrolling factors, the loop permutation of this layer, etc.).

PatDNN extracts the pattern/connectivity information from DNN models with computational graph optimizations, and determines the tuning-related parameters by the auto-tuning. This LR is used for PatDNN's following optimizations: (1) filter kernel reordering, which operates on kernel pattern and connectivity-related information, i.e., specifically the compressed weight storage structure; and (2) load redundancy elimination, which requires each kernel's pattern, the connectivity between kernels and input/output channels, and the exact input/output tile size and unroll factor. After these optimizations, high-level LR can generate compressed model and associated optimized model execution code by using the pattern-related information and other basic layer information extracted from DNN models, (e.g., the kernel size, computation stride, computation dilation, etc.). FIG. 7 shows the optimization flow and two sample code skeletons (+Reorder and +LRE) for these two optimizations, respectively.

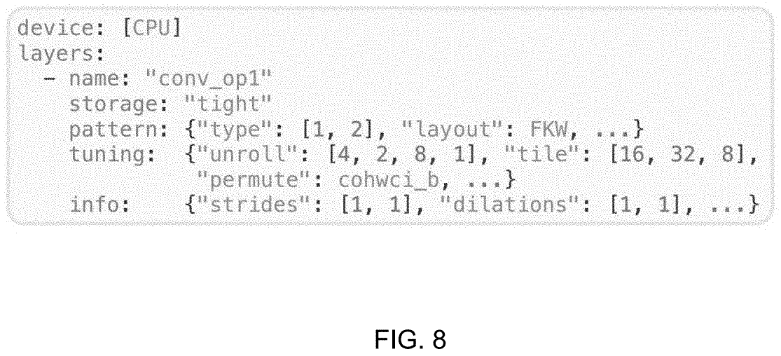

FIG. 8 shows a simplified LR example for a CONV layer (with 2-D kernels). This LR will generate execution code for the CPU (device). Two types of kernel patterns ([1, 2]) present in this layer (patterns) and the filter kernels' pattern layout is specified by our FKW compressed weight storage format (discussed below in detail). Its computation loop permutation is cohwci_b, i.e., in the order of output channel, output height, output width, and input channel, with blocking and unrolling. Their blocking sizes are specified in tile. Their unrolling factors are specified in unroll. FIG. 7 (+Reorder) also shows the execution code generated from this LR, in which the outer loops iterating on all tiles are omitted. The inner-most iteration processes kernels in each filter in the order of their pattern types, i.e., all kernels with pattern 1 in each filter will be processed at first, then kernels with pattern 2. This code optimization does not require any loop control-flows. This is guaranteed by our filter kernel reorder that is introduced in Section 5.2 in details.

Filter Kernel Reorder (FKR)

Kernel pattern and connectivity pruning offer better opportunities to address the performance challenges in non-structured pruning thanks to its better regularity. Specifically, Filter kernel reorder (FKR) is designed to address two key challenges, i.e., heavy control-flow instructions, and thread divergence and load imbalance. Our basic insight is: for a specific DNN layer, the patterns of all kernels are already known after model training, so the inference computation pattern is also known before model deployment. FKR leverages this knowledge to organize the filters with similar kernels together to improve inter-thread parallelization and order the same kernels in a filter together to improve intra-thread parallelization.

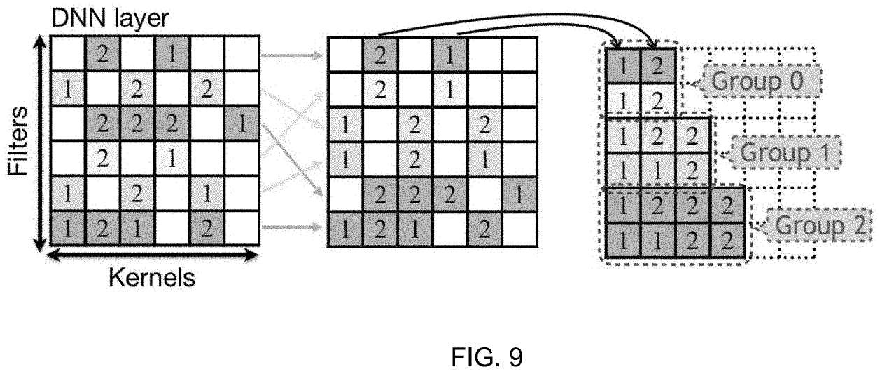

FIG. 9 explains FKR with a simplified example. Here, a matrix represents a CONV layer of DNN and each cell is a kernel with pattern type denoted by the number on it. Empty kernels are the ones pruned by connectivity pruning. The kernels in the same row belong to the same filter, and are marked with the same color.

Before the reorder, kernels with different patterns are distributed in this DNN layer. When performing the convolution operation directly, the execution code will contain many branches (as the +No-opt code in FIG. 7) that incur significant instruction pipeline stalls and thread divergences, hurting both instruction- and thread-level parallelism. According to our experimental results in Section 6, this version results in sub-optimal performance.

FKR comprises two steps: filter reorder and kernel reorder. The filter reorder organizes similar filters next to each other and the kernel reorder groups kernels with identical patterns in each filter together. Particularly, the filter similarity used in filter reorder is decided by two factors: first, the number of non-empty kernels in each filter (i.e., the length of each filter); and second, for filters with the same length, the number of kernels at identical positions with identical pattern IDs when the kernels in each filter are ordered according to these IDs.

After the reorder, the filters with the same length are grouped together, and in each group, the filters with the highest degree of similarity are ordered next to each other. The code+Reorder in FIG. 7 is for the execution of this reordered layer. This code shows much better instruction-level parallelism because it eliminates all branches. In addition, it also allows the better exploration of thread-level parallelism, because it results in large thread execution similarity and good load balance, particularly, considering the example of mapping the filters in the same group to the same GPU thread block.

Compressed DNN Weight Storage (FKW Format)

After FKR, the LR stores the DNN's weights in a novel compact format (called FKW, standing for Filter-Kernel-Weight format). Compared with existing compact data formats (like CSR), FKW is higher-level and results in much less extra structure overhead (i.e., the total size of all index arrays that are used for weights data access). In addition, FKW leverages the pattern information, and stores the kernels with the FKR information that will support later branch-less DNN execution. Other compact data formats cannot support this.

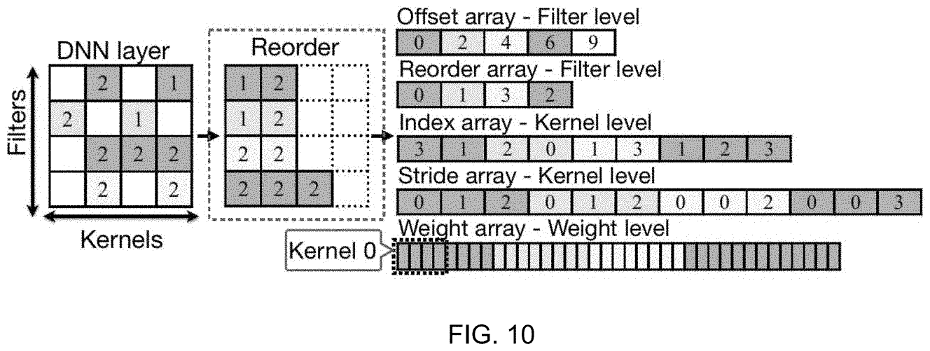

FIG. 10 shows an example. This DNN layer comprises four filters, each with 2, 2, 2, and 3 (after FKR) non-empty kernels, respectively. The two kernels in the first filter (marked as blue) have pattern 1 and 2, corresponding to the input channel 3 and 1, respectively. FKW uses five arrays to represent this DNN layer: offset array, reorder array, index array, stride array, and weight array. The offset array and reorder array store filter-level information, index array and stride array store kernel-level, and the weight array stores actual weights.

More specifically, the offset array stores the offset of each filter (in terms of the number of non-empty kernels). In FIG. 10, the offset of filter 0 is 0, and the offset of filter 1 is 2 because there are two kernels in filter 0, and so on. The reorder array shows the reorder information that is used for accumulating the computation output to the correct output channel. In FIG. 10, the reorder array tells us that filter 2 and filter 3 have been switched and their computation results should also be switched to the corresponding output channel. The index array represents the corresponding input channel for each non-empty kernel. In FIG. 10, kernel 1 in filter 0 corresponds to the input channel 3, and kernel 2 corresponds to the input channel 1. So, the first two elements in the index array are 3 and 1, respectively. The stride array denotes the number of kernels in each pattern within the same filter. In FIG. 10, the filter 0 has the stride array values 0, 1, and 2, denoting that the filter 0 has 1 kernel with pattern 1 (1=1−0), and 1 kernel with pattern 2 (1=2−1). In this example, each kernel has four (non-zero) weights, so each filter has 8, 8, 8, and 12 weights (after FKR), respectively.

Load Redundancy Elimination (LRE)

As discussed before, irregular memory access (in the form of array indirection) is also a major cause of inefficient execution of weight pruned DNNs. PatDNN uses two techniques to address this issue: (1) a conventional input tiling to improve the cache performance; and (2) the optimized code generation with the help of the pre-defined pattern information. The first technique, specifically the determination of the optimal tiling size is further discussed below. This section focuses on the second technique, specifically, introducing our novel redundant register load elimination optimization applied in code generation procedure.

In DNN execution, such as a convolution operation, the data access pattern of the input and output is decided by the (none-zero elements) patterns of kernels that are already known after training. Therefore, it is possible to generate the optimized data access code with this information for each pattern of kernels and call them dynamically during the DNN execution. The generated codes consist of all statically determined data access instructions for the kernel-level computation with a careful instruction reorganization to (1) eliminate all indirect memory accesses; and (2) eliminate all redundant register load operations. The elimination of all indirect memory accesses is relatively straightforward, because in all data access instructions, the index of input data can be directly calculated from kernel pattern. We next explain two novel register-level load redundancy elimination methods in details.

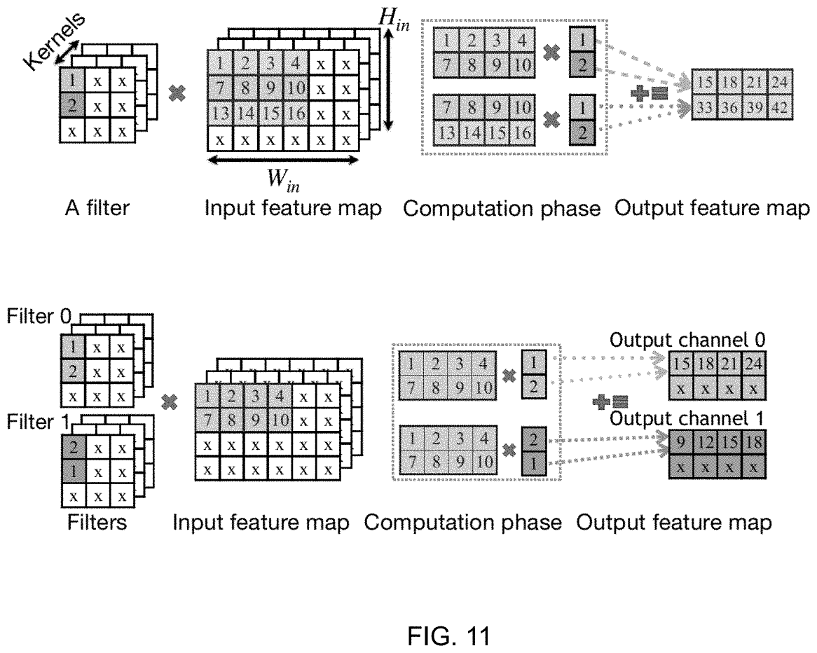

FIG. 11 illustrates both register-level load redundancy eliminations: the top drawing is within each kernel, and the bottom drawing is among multiple kernels. Within each kernel, the load redundancy is caused by the convolution operation. In the example (shown on the upper part of FIG. 11), the kernel value 1 requires the elements in the first two rows of the input matrix while value 2 requires the second and third rows. The elements in the second row [7, 8, 9,10] are loaded twice (from cache to register). PatDNN eliminates this load redundancy by explicitly reusing the (SIMD) registers that already hold the required data (like the second row in the above example).

Multiple kernels on the same position of different filters may share the same pattern and input channel. The input data required by these kernels are exactly identical. The lower part of FIG. 11 shows a concrete example. If the computation of these filters on identical data is packed together, the possible redundant load of this input can be eliminated. PatDNN explores this optimization when it generates the optimized memory access code. The FKR organizes the kernels (in different filters) with identical patterns together. Together with a filter-level (or output channel) loop unrolling when processing these kernels, the redundant register load is eliminated. FIG. 7 (+LRE) shows an example of this unrolling code.

The above two redundancy elimination opportunities are more straightforward to exploit for dense models where the memory accesses of kernel weights are continuous and the data reuse pattern is periodically repeated. However, it is very challenging (or even not possible) to exploit for pruned sparse models with irregular memory accesses, because it is hard to detect the data reuse pattern (or the data reuse pattern does not even exist). Our pattern-based pruning can preserve the data reuse patterns and help the compiler to detect them, thus re-enabling these two kinds of register-level load redundancy elimination.

Parameter Auto-tuning

Many configuration parameters require careful tuning to guarantee the performance of the generated execution code. However, manual tuning is tedious, and hard to yield the optimal code. Therefore, PatDNN also includes an auto-tuning component for selecting the best execution configuration.

It has two parts: first, an explorer model based on Genetic Algorithm to generate the configuration exploration space; and second, a performance estimation model created from our historical data to predict the possible best configuration and performance for a given hardware. Compared with simulated annealing in TVM, our explorer model supports better parallelism because it allows the initialization of an arbitrary number of chromosomes to start the search. For a typical (large-scale) DNN like VGG-16, our exploration can complete in 3-5 ms. During the exploration, history data is also collected for training the performance estimator (based on Multilayer Perceptron and least square regression loss). The advantage of this approach is that when deploying PatDNN on a new platform, it can give a quick prediction of the optimal configuration parameters as well as the possible execution time. In addition, these tuning parameters are crucial to the performance of our PatDNN execution, thus need to be carefully tuned by our auto-tuning module including: data placement configurations on GPU, tiling sizes, loop permutations, and loop unrolling factors.

Evaluation

This section evaluates the execution performance of PatDNN by comparing it with three state-of-the-art DNN inference acceleration frameworks, TFLite [10], TVM [5], and MNN [1]. All major optimizations of these frameworks (and our PatDNN) are summarized in Table 1.

Methodology

Evaluation Objective: Our overall evaluation demonstrates that achieving real-time inference of large-scale DNNs on modern mobile devices is possible with PatDNN. Specifically, the evaluation has five objectives: (1) demonstrating that PatDNN outperforms existing state-of-the-art DNN frameworks without any accuracy compromise; (2) studying the performance effect of our key compiler optimizations and explaining the reasons for performance improvement; (3) further confirming the performance of PatDNN by comparing its pure GFLOPS with our optimized dense baseline; (4) showing that PatDNN performs similarly on different mobile platforms, i.e., PatDNN has a good portability; and (5) unveiling the impact of pattern count selections on both the accuracy and performance.

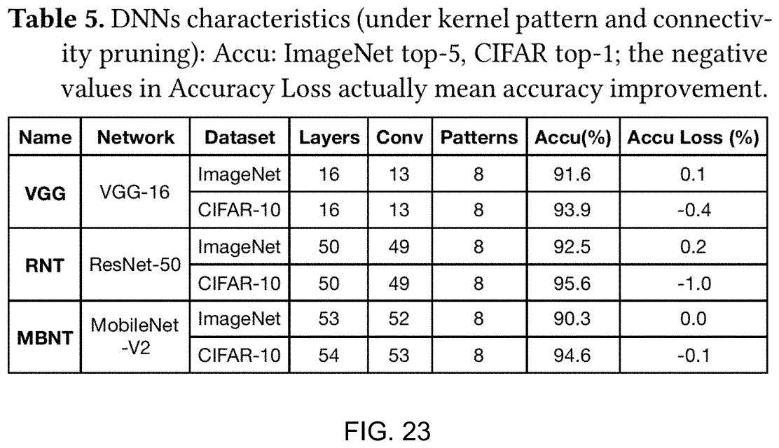

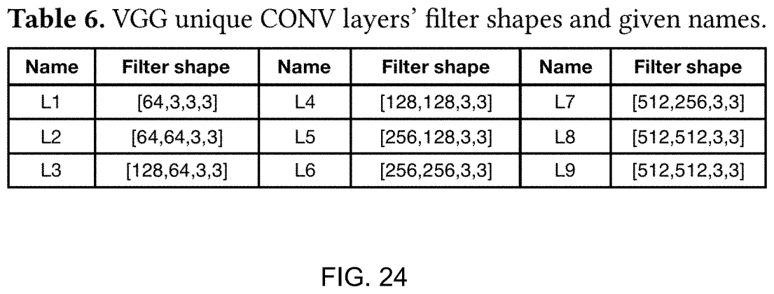

DNNs and Datasets: PatDNN was evaluated on three main-stream DNNs, VGG-16 (VGG), ResNet-50 (RNT), and Mobile-Net-V2 (MBNT). They were trained on two datasets, ImageNet and CIFAR-10. Table 5 (FIG. 23) characterizes these trained DNNs. Some information is omitted due to the space constraint, e.g., a uniform CONV pruning rate for VGG and RNT is 8×, and 4.4×, respectively (with uniform 3.6× connectivity pruning rate). VGG has 13 CONV layers, and 5 of them have identical structures to others. Table 6 (FIG. 24) lists the filter shape ([#output channel, #input channel, kernel height, and kernel width]) of these 9 unique layers and gives them a short name each.

Evaluation Platforms and Running Configurations: Our experiments were conducted on a Samsung Galaxy S10 cell phone with the latest Qualcomm Snapdragon 855 mobile platform that consists of a Qualcomm Kryo 485 Octa-core CPU and a Qualcomm Adreno 640 GPU. Our portability tests were conducted on a Xiaomi POCOPHONE F1 phone with a Qualcomm Snapdragon 845 that consists of a Kryo 385 Octa-core CPU and an Adreno 630 GPU, and an Honor Magic 2 phone with a Kirin 980 that comprises an ARM Octa-core CPU and a Mali-G76 GPU. All tests were run 50 times on different input (images) with 8 threads on CPU, and all pipelines on GPU. Because multiple runs do not vary significantly, this section only reports the average time for readability. Because CONV layers are most time-consuming, accounting for more than 95% (90% for VGG) of the total execution time, our evaluation focused on the CONV layers. All runs were tuned to their best configurations, e.g., Winograd optimization [32] was used for all dense runs, and 16-bit float point was used for all GPU runs.

Overall Performance

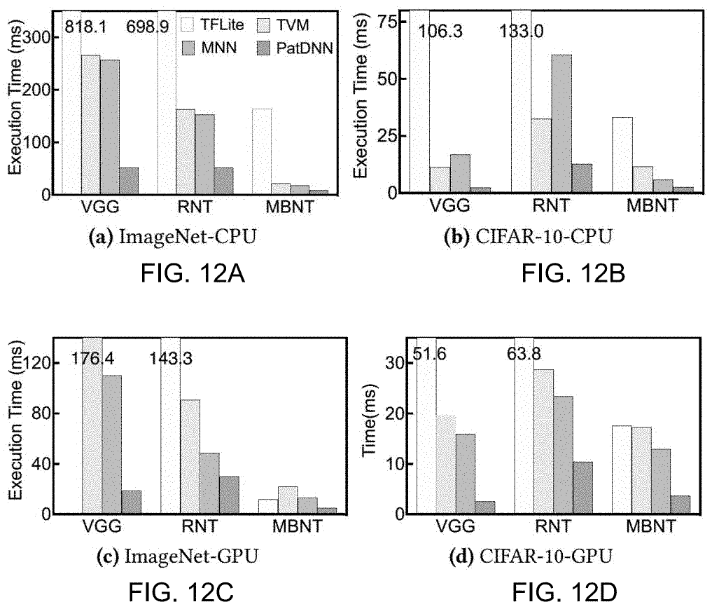

FIG. 12 shows the overall CPU and GPU performance of PatDNN compared to TFLite, TVM, MNN on all six trained DNNs. PatDNN outperformed all other frameworks for all cases. On CPU, PatDNN achieved 12.3× to 44.5× speedup over TFLite, 2.4× to 5.1× over TVM, and 1.9× to 7.1× over MNN, respectively. On GPU, PatDNN achieved 2.5× to 20×, 2.8× to 11.4×, and 1.6× to 6.2× speedup over TFLite, TVM, and MNN, respectively. For the largest DNN (VGG) and largest data set (ImageNet), PatDNN completed CONV layers on a single input within 18.9 ms on GPU. Even including the other rest layers (like FC), PatDNN can still meet the real-time requirement (usually 30 frames/sec, i.e., 33 ms/frame).

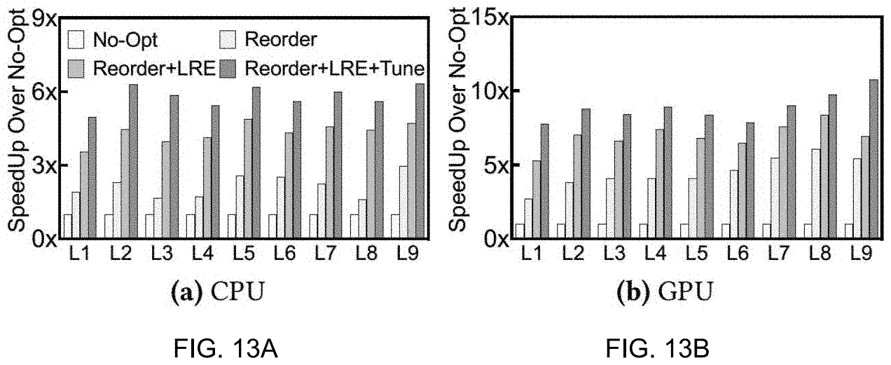

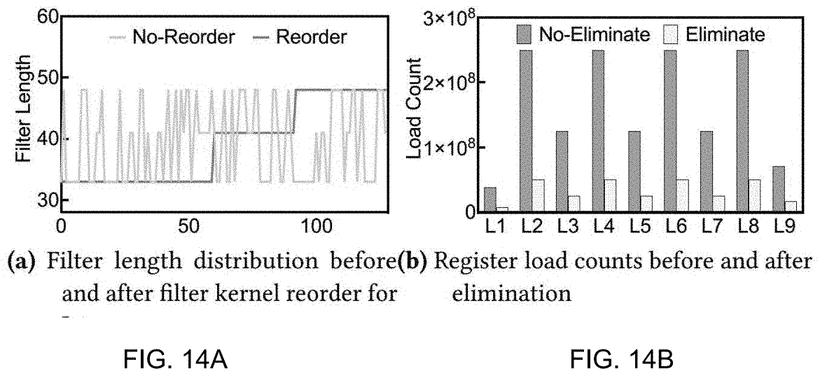

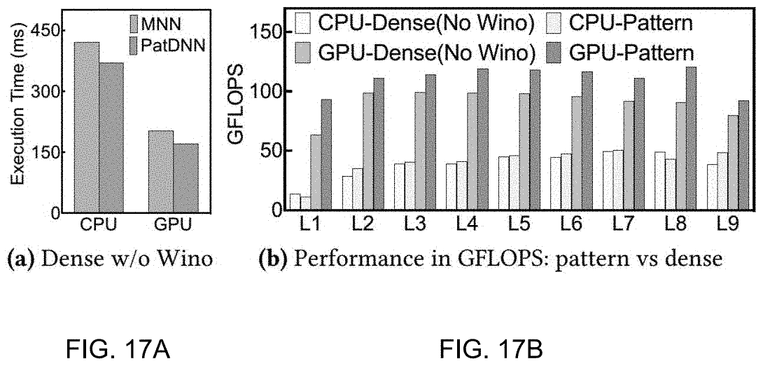

PatDNN outperformed other frameworks for two major reasons. First, its dense version is already 1.1× to 1.6× faster than TVM and MNN on mobile platforms because of some extra optimizations (as shown in Table 1). FIG. 17A shows that PatDNN's dense version is faster than MNN on VGG, our largest DNN. Second, the pattern-based pruning reduces the overall computation by 3× to 8×. Such computation reduction unfortunately cannot transfer to performance gains directly. We confirmed this by implementing an optimized sparse matrix version of PatDNN based on CSR [11], which shows almost the same speed to PatDNN's dense version. However, the subsequent compiler-level optimizations (filter kernel reorder, load redundancy elimination, auto-tuning, and compressed weight storage) successfully convert this computation reduction into real performance gains. We conducted a more detailed study on these optimizations in the next Section, and FIG. 13 shows a break-down of these optimizations contributions. FIGS. 14 to 16 provide a detailed analysis of the underlying reasons.

Optimization Evaluation

This section studies the effect of our key compiler optimizations and shows that our PatDNN's good performance mainly comes from these pattern-enabled optimizations. This section also compares the extra structure overhead between FKW and CSR. Constrained by space, we only report the results of VGG, our most complex DNN, on the most widely accepted dataset (ImageNet). Experiments on other DNNs and datasets show the same trend. The other sections also use VGG on ImageNet as a representative example.

FIG. 13 reports the speedup of the versions with optimizations over the version without any optimization on each unique CONV layer of VGG on CPU and GPU, respectively. On CPU, reorder brings 1.6× to 3.0× speedup, load redundancy eliminations bring additional 1.6× to 2.8× speedup, and parameter tuning brings additional 1.2× to 1.9× speedup. On GPU, these numbers are 2.7× to 6.1×, 1.5× to 3.3× and 1.4× to 3.8×. FKR has been found to more beneficial on GPUs than on CPUs, because GPU performance is more sensitive to the thread divergence and load balance due to its massive parallel nature. We next study why these optimizations work.

Filter Kernel Reorder: FIG. 14A reports the filter length distribution of VGG L4 before and after FKR. Before reorder, the filters with varied lengths are distributed randomly, resulting in significant load imbalance if assigning them to different threads. After reorder, the filters are grouped into three groups, and the filters within each group have identical lengths. Each group could be executed by CPU threads simultaneously, or mapped to the same GPU thread block. Load Redundant Elimination: FIG. 14B reports the register load counts before and after LRE for each unique CONV of VGG. It shows that our register LRE can significantly reduce the number of register loads. Note that even if register load has lower latency than cache or memory load, the memory/cache performance has nevertheless been aggressively optimized by conventional tiling. Thus, the significant performance gains must have been achieved with the reduced number of register loads.

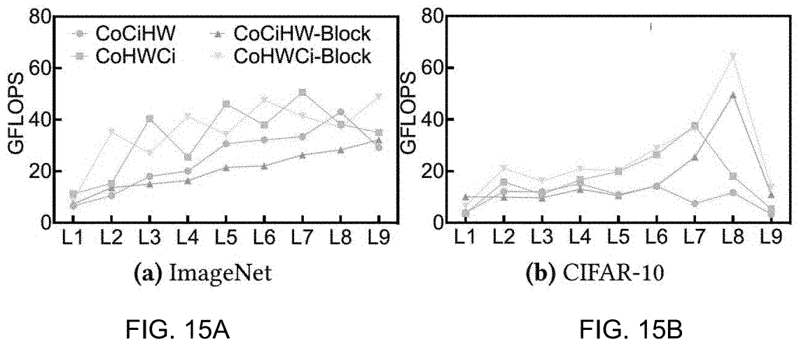

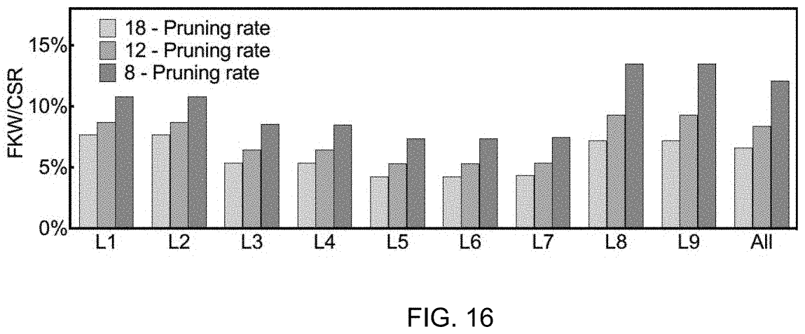

Auto-tuning: FIGS. 15A-B report the CPU performance (in GFLOPS) of each unique VGG CONV layer with varied loop permutations, and with or without blocking on ImageNet and CIFAR-10, respectively. It shows that different inputs and layers may require different configurations. Proper tuning will bring significant benefits. Constrained by space, we omit the GPU results and tuning results about GPU data placement. Compressed Weight Storage: FIG. 16 shows the extra data structure overhead (i.e., the size of data structures other than weights) of FKW over CSR on each unique VGG CONV layer with three kinds of pruning rates, 18×, 12×, and 8× respectively. For each one, FKW saves 93.4%, 91.6%, and 87.9% extra data structure overhead over CSR in total, resulting in 46.7%, 45.8%, and 43.9% overall storage space saving.

PatDNN Performance Analysis in GFLOPS

To further analyze the performance of PatDNN, this section compares its pure GFLOPS with our dense implementation. To conduct an apple-to-apple comparison, we turn off the Winograd optimization that transforms the convolution operation to matrix-multiplication for a trade-off between the computation reduction and operation conversion overhead. FIG. 17A shows that our dense version can serve as an optimized baseline, because it is even faster than MNN.

FIG. 17B shows that our pattern-based (sparse) PatDNN achieves comparable GFLOPS to our optimized dense baseline on CPU, and outperforms it on GPU. It implies that the memory performance of PatDNN is comparable to the dense baseline on CPU and even better than it on GPU. This benefits from our model compression and memory load (and register load) reductions. Without pattern-based pruning, the input, output, and DNN model compete for the limited memory/cache resource; after pruning, only the input and output compete for it. PatDNN also reduces the overall computation; thus, it significantly outperforms all other mobile frameworks.

Portability Study

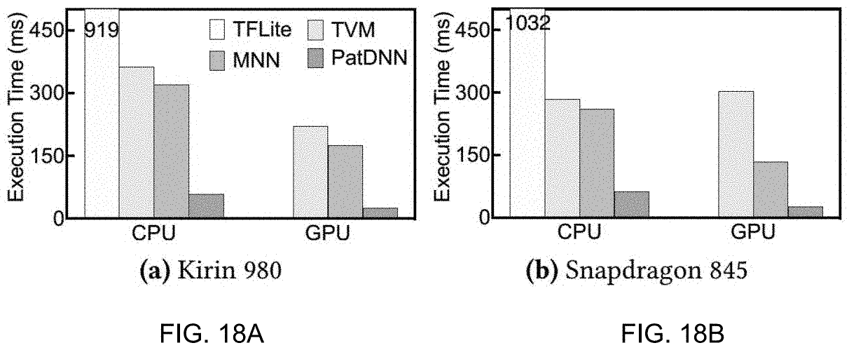

PatDNN is also evaluated on two other platforms to confirm its portability. FIGS. 18A-B shows the result. On these platforms, PatDNN also outperforms other frameworks. Particularly, other frameworks run much slower on Magic 2 than on Snapdragon 855; however, PatDNN performs more stably. This is because our pattern-based pruning leads to fewer computations and fewer memory accesses thus reducing the memory bandwidth pressure.

Impact of Pattern Counts

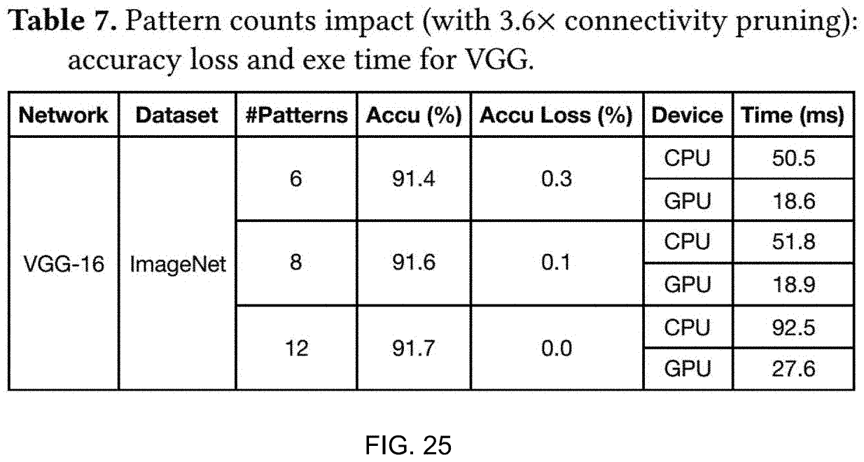

Table 7 (FIG. 25) reports the impact of the pattern count selection on both the accuracy and execution time, under 3.6× uniform connectivity pruning rate. As increasing pattern counts, the accuracy increases slightly, however, the performance drops quickly. Our evaluation selects 8 patterns that result in ideal performance with a negligible accuracy loss.

Discussion

Generality: The techniques proposed in PatDNN are general enough to be applied to other platforms. Compared to laptops or servers, mobile platforms are more resource-constrained, making it is more challenging to achieve real-time execution. However, the need for real-time DNN execution is crucial due to many important mobile applications. In fact, in addition to the mobile platforms, we also tested PatDNN on the latest Raspberry Pi 4 platform. It shows a similar speedup over other frameworks like TVM. We believe that it is a promising research direction to improve PatDNN's portability by incorporating it with TVM that emphasizes the DNN execution on varied computing devices.

Dense vs. Sparse DNNs: General end-to-end DNN inference acceleration frameworks like TFLite, TVM, and MNN do not support sparse DNN execution. If we simply add sparse DNN support with random pruning and general compression storage (like CSR) to these frameworks, it is expected that their speed cannot be improved significantly as shown in the results of PatDNN's CSR implementation. Although there is potential to improve the performance with coarse-grained structured pruning (that prunes whole filters/channels), the accuracy will be obviously degraded as we discussed before. From this perspective, PatDNN opens a new door to accelerate DNN execution with a compression/compiler-optimization co-design. With such co-design, sparse (or compressed) DNN execution becomes a more promising solution in resource-constraint environments than dense DNN.

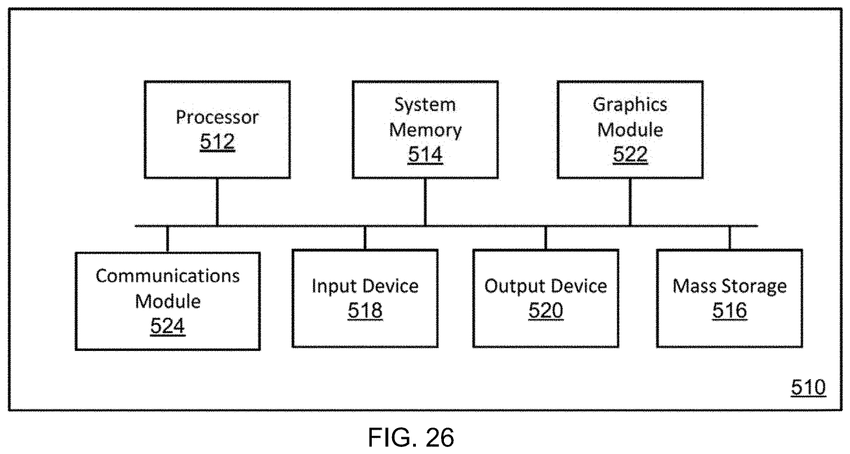

The methods, operations, modules, and systems described herein for achieving real-time DNN execution on mobile devices with pattern-based weight pruning may be implemented in one or more computer programs executing on a programmable computer system. FIG. 26 is a simplified block diagram illustrating an exemplary computer system 510, on which the one or more computer programs may operate as a set of computer instructions. The computer system 510 includes, among other things, at least one computer processor 512, system memory 514 (including a random access memory and a read-only memory) readable by the processor 512. The computer system 510 also includes a mass storage device 516 (e.g., a hard disk drive, a solid-state storage device, an optical disk device, etc.). The computer processor 512 is capable of processing instructions stored in the system memory or mass storage device. The computer system additionally includes input/output devices 518, 520 (e.g., a display, keyboard, pointer device, etc.), a graphics module 522 for generating graphical objects, and a communication module or network interface 524, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

### REFERENCES

[1] Alibaba. 2019. MNN. https://github.com/alibaba/MNN
[2] Sourav Bhattacharya and Nicholas D Lane. 2016. From smart to deep: Robust activity recognition on smartwatches using deep learning. In 2016 IEEE International Conference on Pervasive Computing and Communication Workshops (PerCom Workshops). IEEE, 1-6.
[3] Ivica Boticki and Hyo-Jeong So. 2010. Quiet captures: A tool for capturing the evidence of seamless learning with mobile devices. In Proceedings of the 9th International Conference of the Learning Sciences-Volume 1. International Society of the Learning Sciences, 500-507.
[4] Stephen Boyd, Neal Parikh, Eric Chu, Borja Peleato, and Jonathan Eckstein. 2011. Distributed optimization and statistical learning via the alternating direction method of multipliers. Foundations and Trends® in Machine Learning 3,1 (2011), 1-122.
[5] Tianqi Chen, Thierry Moreau, Ziheng Jiang, Lianmin Zheng, Eddie Yan, Haichen Shen, Meghan Cowan, Leyuan Wang, Yuwei Hu, Luis Ceze, et al. 2018. TVM: An automated end-to-end optimizing compiler for deep learning. In 13th USENIX Symposium on Operating Systems Design and Implementation (OSDI 18). 578-594.
[6] Matthieu Courbariaux, Yoshua Bengio, and Jean-Pierre David. 2015. Binaryconnect: Training deep neural networks with binary weights during propagations. In Advances in neural information processing systems. 3123-3131.
[7] Matthieu Courbariaux, Itay Hubara, Daniel Soudry, Ran El-Yaniv, and Yoshua Bengio. 2016. Binarized neural networks: Training deep neural networks with weights and activations constrained to +1 or −1. arXiv preprint arXiv:1602.02830 (2016).
[8] Xiaoliang Dai, Hongxu Yin, and Niraj K Jha. 2017. NeST: a neural network synthesis tool based on a grow-and-prune paradigm. arXiv preprint arXiv:1711.02017 (2017).
[9] Yunbin Deng. 2019. Deep Learning on Mobile Devices—A Review. arXiv preprint arXiv:1904.09274 (2019).
[10] Google. 2019. TensorFlow Lite. https://www.tensorflow.org/mobile/tflite/[11] Joseph L Greathouse, Kent Knox, Jakub Pola, Kiran Varaganti, and Mayank Daga. 2016. c1SPARSE: A Vendor-Optimized Open-Source Sparse BLAS Library. In Proceedings of the 4th International Workshop on OpenCL. ACM, 7.
[12] Yiwen Guo, Anbang Yao, and Yurong Chen. 2016. Dynamic network surgery for efficient dnns. In Advances In Neural Information Processing Systems. 1379-1387.
[13] Suyog Gupta, Ankur Agrawal, Kailash Gopalakrishnan, and Pritish Narayanan. 2015. Deep learning with limited numerical precision. In International Conference on Machine Learning. 1737-1746.
[14] Song Han, Huizi Mao, and William J Dally. 2015. Deep compression: Compressing deep neural networks with pruning, trained quantization and huffman coding. arXiv preprint arXiv:1510.00149 (2015).
[15] Song Han, Jeff Pool, John Tran, and William Dally. 2015. Learning both weights and connections for efficient neural network. In Advances in Neural Information Processing Systems. 1135-1143.
[16] Seungyeop Han, Haichen Shen, Matthai Philipose, Sharad Agar-wal, Alec Wolman, and Arvind Krishnamurthy. 2016. Mcdnn: An approximation-based execution framework for deep stream processing under resource constraints. In Proceedings of the 14th Annual International Conference on Mobile Systems, Applications, and Services. ACM, 123-136.
[17] Kaiming He, Xiangyu Zhang, Shaoqing Ren, and Jian Sun. 2016. Deep residual learning for image recognition. In Proceedings of the IEEE Conference on Computer Vision and Pattern Recognition. 770-778.
[18] Yihui He, Ji Lin, Zhijian Liu, Hanrui Wang, Li-Jia Li, and Song Han. 2018. AMC: AutoML for Model Compression and Acceleration on Mobile Devices. In European Conference on Computer Vision. Springer, 815-832.
[19] Yihui He, Xiangyu Zhang, and Jian Sun. 2017. Channel Pruning for Accelerating Very Deep Neural Networks. In Computer Vision (ICCV), 2017 IEEE International Conference on. IEEE, 1398-1406.
[20] Parker Hill, Animesh Jain, Mason Hill, Babak Zamirai, Chang-Hong Hsu, Michael A Laurenzano, Scott Mahlke, Lingjia Tang, and Jason Mars. 2017. Deftnn: Addressing bottlenecks for dnn execution on GPUs via synapse vector elimination and near-compute data fission. In Proceedings of the 50th Annual IEEE/ACM International Symposium on Microarchitecture. ACM, 786-799.
[21] Mingyi Hong, Zhi-Quan Luo, and Meisam Razaviyayn. 2016. Convergence analysis of alternating direction method of multipliers for a family of nonconvex problems. SIAM Journal on Optimization 26,1 (2016), 337-364.
[22] Itay Hubara, Matthieu Courbariaux, Daniel Soudry, Ran El-Yaniv, and Yoshua Bengio. 2016. Binarized neural networks. In Advances in neural information processing systems. 4107-4115.
[23] Itay Hubara, Matthieu Courbariaux, Daniel Soudry, Ran El-Yaniv, and Yoshua Bengio. 2017. Quantized neural networks: Training neural networks with low precision weights and activations. The Journal of Machine Learning Research 18,1 (2017), 6869-6898.
[24] Loc N Huynh, Youngki Lee, and Rajesh Krishna Balan. 2017. Deepmon: Mobile gpu-based deep learning framework for continuous vision applications. In Proceedings of the 15th Annual International Conference on Mobile Systems, Applications, and Services. ACM, 82-95.
[25] Sergey Ioffe and Christian Szegedy. 2015. Batch normalization: Accelerating deep network training by reducing internal covariate shift. arXiv preprint arXiv:1502.03167 (2015).
[26] Andrej Karpathy, George Toderici, Sanketh Shetty, Thomas Leung, Rahul Sukthankar, and Li Fei-Fei. 2014. Large-scale video classification with convolutional neural networks. In Proceedings of the IEEE conference on Computer Vision and Pattern Recognition. 1725-1732.
[27] Diederik P. Kingma and Jimmy Ba. 2014. Adam: A Method for Stochastic Optimization. In Proceedings of the International Conference on Learning Representations (ICLR).
[28] Nicholas D Lane, Sourav Bhattacharya, Petko Georgiev, Claudio For-livesi, Lei Jiao, Lorena Qendro, and Fahim Kawsar. 2016. Deepx: A software accelerator for low-power deep learning inference on mobile devices. In Proceedings of the 15th International Conference on Information Processing in Sensor Networks. IEEE Press, 23.
[29] Nicholas D Lane, Sourav Bhattacharya, Petko Georgiev, Claudio For-livesi, and Fahim Kawsar. 2015. An early resource characterization of deep learning on wearables, smartphones and internet-of-things devices. In Proceedings of the 2015 international workshop on internet of things towards applications. ACM, 7-12.
[30] Nicholas D Lane, Sourav Bhattacharya, Akhil Mathur, Petko Georgiev, Claudio Forlivesi, and Fahim Kawsar. 2017. Squeezing deep learning into mobile and embedded devices. IEEE Pervasive Computing 16,3 (2017), 82-88.
[31] Nicholas D Lane, Petko Georgiev, and Lorena Qendro. 2015. DeepEar: robust smartphone audio sensing in unconstrained acoustic environments using deep learning. In Proceedings of the 2015 ACM International Joint Conference on Pervasive and Ubiquitous Computing. ACM, 283-294.
[32] Andrew Lavin and Scott Gray. 2016. Fast algorithms for convolutional neural networks. In Proceedings of the IEEE Conference on Computer Vision and Pattern Recognition. 4013-4021.
[33] Vadim Lebedev and Victor Lempitsky. 2016. Fast convnets using group-wise brain damage. In Proceedings of the IEEE Conference on Computer Vision and Pattern Recognition. 2554-2564.
[34] Honglak Lee, Roger Grosse, Rajesh Ranganath, and Andrew Y Ng. 2009. Convolutional deep belief networks for scalable unsupervised learning of hierarchical representations. In Proceedings of the 26th annual international conference on machine learning. ACM, 609-616.
[35] Cong Leng, Hao Li, Shenghuo Zhu, and Rong Jin. 2017. Extremely low bit neural network: Squeeze the last bit out with admm. arXiv preprint arXiv:1707.09870 (2017).
[36] Hao Li, Asim Kadav, Igor Durdanovic, Hanan Samet, and Hans Peter Graf. 2017. Pruning filters for efficient convnets. In International Conference on Learning Representations (ICLR).
[37] Darryl Lin, Sachin Talathi, and Sreekanth Annapureddy. 2016. Fixed point quantization of deep convolutional networks. In International Conference on Machine Learning. 2849-2858.
[38] Baoyuan Liu, Min Wang, Hassan Foroosh, Marshall Tappen, and Marianna Pensky. 2015. Sparse convolutional neural networks. In Proceedings of the IEEE Conference on Computer Vision and Pattern Recognition. 806-814.
[39] Sijia Liu, Jie Chen, Pin-Yu Chen, and Alfred Hero. 2018. Zeroth-Order Online Alternating Direction Method of Multipliers: Convergence Analysis and Applications. In International Conference on Artificial Intelligence and Statistics. 288-297.
[40] Sicong Liu, Yingyan Lin, Zimu Zhou, Kaiming Nan, Hui Liu, and Jun-zhao Du. 2018. On-demand deep model compression for mobile devices: A usage-driven model selection framework. In Proceedings of the 16th Annual International Conference on Mobile Systems, Applications, and Services. ACM, 389-400.
[41] Xiaolong Ma, Fu-Ming Guo, Wei Niu, Xue Lin, Jian Tang, Kai sheng Ma, Bin Ren, and Yanzhi Wang. 2019. Pconv: The missing but desirable sparsity in dnn weight pruning for real-time execution on mobile devices. arXiv preprint arXiv:1909.05073 (2019).
[42] Huizi Mao, Song Han, Jeff Pool, Wenshuo Li, Xingyu Liu, Yu Wang, and William J Dally. 2017. Exploring the regularity of sparse structure in convolutional neural networks. arXiv preprint arXiv:1705.08922 (2017).
[43] Kaoru Ota, Minh Son Dao, Vasileios Mezaris, and Francesco GB De Na-tale. 2017. Deep learning for mobile multimedia: A survey. ACM Transactions on Multimedia Computing, Communications, and Applications (TOMM) 13, 3s (2017), 34.
[44] Angshuman Parashar, Minsoo Rhu, Anurag Mukkara, Antonio Puglielli, Rangharajan Venkatesan, Brucek Khailany, Joel Emer, Stephen W Keckler, and William J Dally. 2017. SCNN: An Accelerator for Compressed-sparse Convolutional Neural Networks. In Proceedings of the 44th Annual International Symposium on Computer Architecture. ACM, 27-40.
[45] Eunhyeok Park, Junwhan Ahn, and Sungjoo Yoo. 2017. Weighted-entropy-based quantization for deep neural networks. In Proceedings of the IEEE Conference on Computer Vision and Pattern Recognition. 7197-7205.
[46] Damian Philipp, Frank Dun, and Kurt Rothermel. 2011. A sensor network abstraction for flexible public sensing systems. In 2011 IEEE Eighth International Conference on Mobile Ad-Hoc and Sensor Systems. IEEE, 460-469.
[47] Qualcomm. 2019. Snapdragon 855. https://www.qualcomm.com/products/snapdragon-855-mobile-platform
[48] Mohammad Rastegari, Vicente Ordonez, Joseph Redmon, and Ali Farhadi. 2016. Xnor-net: Imagenet classification using binary convolutional neural networks. In European Conference on Computer Vision. Springer, 525-542.
[49] Ao Ren, Tianyun Zhang, Shaokai Ye, Wenyao Xu, Xuehai Qian, Xue Lin, and Yanzhi Wang. 2019. ADMM-NN: an algorithm-hardware co-design framework of DNNs using alternating direction methods of multipliers. In International Conference on Architectural Support for Programming Languages and Operating Systems (ASPLOS). ACM.
[50] Mary M Rodgers, Vinay M Pai, and Richard S Conroy. 2014. Recent advances in wearable sensors for health monitoring. IEEE Sensors Journal 15, 6 (2014), 3119-3126.
[51] Mark Sandler, Andrew Howard, Menglong Zhu, Andrey Zhmoginov, and Liang-Chieh Chen. 2018. Mobilenetv2: Inverted residuals and linear bottlenecks. In Proceedings of the IEEE Conference on Computer Vision and Pattern Recognition. 4510-4520.
[52] Karen Simonyan and Andrew Zisserman. 2014. Very deep convolutional networks for large-scale image recognition. arXiv preprint arXiv:1409.1556 (2014).
[53] Nicolas Vasilache, Oleksandr Zinenko, Theodoros Theodoridis, Priya Goyal, Zachary DeVito, William S Moses, Sven Verdoolaege, Andrew Adams, and Albert Cohen. 2018. Tensor comprehensions: Framework-agnostic high-performance machine learning abstractions. arXiv preprint arXiv:1802.04730 (2018).
[54] Wei Wen, Chunpeng Wu, Yandan Wang, Yiran Chen, and Hai Li. 2016. Learning structured sparsity in deep neural networks. In Advances in Neural Information Processing Systems. 2074-2082.
[55] Shmuel Winograd. 1980. Arithmetic complexity of computations. Vol. 33. Siam.
[56] Jiaxiang Wu, Cong Leng, Yuhang Wang, Qinghao Hu, and Jian Cheng. 2016. Quantized convolutional neural networks for mobile devices. In Proceedings of the IEEE Conference on Computer Vision and Pattern Recognition. 4820-4828.
[57] Mengwei Xu, Mengze Zhu, Yunxin Liu, Felix Xiaozhu Lin, and Xu-anzhe Liu. 2018. DeepCache: Principled Cache for Mobile Deep Vision. In Proceedings of the 24th Annual International Conference on Mobile Computing and Networking. ACM, 129-144.
[58] Daniel LK Yamins and James J DiCarlo. 2016. Using goal-driven deep learning models to understand sensory cortex. Nature neuroscience 19, 3 (2016), 356.
[59] Daniel LK Yamins, Ha Hong, Charles F Cadieu, Ethan A Solomon, Darren Seibert, and James J DiCarlo. 2014. Performance-optimized hierarchical models predict neural responses in higher visual cortex. Proceedings of the National Academy ofSciences 111, 23 (2014), 8619-8624.
[60] Shuochao Yao, Shaohan Hu, Yiran Zhao, Aston Zhang, and Tarek Abdelzaher. 2017. Deepsense: A unified deep learning framework for time-series mobile sensing data processing. In Proceedings of the 26th International Conference on World Wide Web. International World Wide Web Conferences Steering Committee, 351-360.
[61] Shaokai Ye, Xiaoyu Feng, Tianyun Zhang, Xiaolong Ma, Sheng Lin, Zhengang Li, Kaidi Xu, Wujie Wen, Sijia Liu, Jian Tang, et al. 2019. Progressive DNN Compression: A Key to Achieve Ultra-High Weight Pruning and Quantization Rates using ADMM. arXiv preprint arXiv:1903.09769 (2019).
[62] Dong Yu and Li Deng. 2011. Deep learning and its applications to signal and information processing [exploratory dsp]. IEEE Signal Processing Magazine 28, 1 (2011), 145-154.
[63] Chaoyun Zhang, Paul Patras, and Hamed Haddadi. 2019. Deep learning in mobile and wireless networking: A survey. IEEE Communications Surveys & Tutorials (2019).
[64] Tianyun Zhang, Shaokai Ye, Yipeng Zhang, Yanzhi Wang, and Makan Fardad. 2018. Systematic Weight Pruning of DNNs using Alternating Direction Method of Multipliers. arXiv preprint arXiv:1802.05747 (2018).
[65] Aojun Zhou, Anbang Yao, Yiwen Guo, Lin Xu, and Yurong Chen. 2017. Incremental network quantization: Towards lossless cnns with low-precision weights. In International Conference on Learning Representations (ICLR).

1. A computer-implemented method for compressing a deep neural network (DNN) model by DNN weight pruning and accelerating DNN execution in a mobile device to achieve real-time inference, the method comprising the steps of:
(a) performing an intra-convolution kernel pruning of the DNN model wherein a fixed number of weights are pruned in each convolution kernel of the DNN model to generate sparse convolution patterns;
(b) performing inter-convolution kernel pruning of the DNN model to generate connectivity sparsity, wherein inter-convolution kernel pruning comprises cutting connections between given input and output channels of the DNN model to remove corresponding kernels;
(c) training the DNN model compressed in steps (a) and (b); and
(d) applying a compiler-assisted DNN acceleration framework to the DNN model trained in (c) to generate code to be executed on the mobile device.

2. The method of claim 1, wherein step (d) includes converting the DNN model trained in (c) into one or more computational graphs and performing one or more compiler optimizations based on the sparse convolution patterns for compressed DNN execution.

3. The method of claim 1, wherein the one or more optimizations are applicable to a CPU or a GPU of the mobile device.

4. The method of claim 1, wherein the one or more optimizations includes performing a high-level fine-grained Layerwise Representation (LR) to capture the sparsity information from (a) and (b).

5. The method of claim 1, wherein the one or more optimizations includes performing filter kernel reordering to organize filters with similar kernels of the DNN model together to improve inter-thread parallelization and order the same kernels in a filter together to improve intra-thread parallelization.

6. The method of claim 1, wherein the one or more optimizations includes storing weights of the DNN model in a compact format.

7. The method of claim 1, wherein the one or more optimizations includes performing load redundancy elimination in the DNN model.

8. The method of claim 1, wherein the one or more optimizations includes automatically tuning configuration parameters.

9. A computer system, comprising:
at least one processor;
memory associated with the at least one processor; and
a program supported in the memory for compressing a deep neural network (DNN) model by DNN weight pruning and accelerating DNN execution in a mobile device to achieve real-time inference, the program containing a plurality of instructions which, when executed by the at least one processor, cause the at least one processor to:
(a) perform an intra-convolution kernel pruning of the DNN model wherein a fixed number of weights are pruned in each convolution kernel of the DNN model to generate sparse convolution patterns;
(b) perform inter-convolution kernel pruning of the DNN model to generate connectivity sparsity, wherein inter-convolution kernel pruning comprises cutting connections between given input and output channels of the DNN model to remove corresponding kernels;
(c) train the DNN model compressed in (a) and (b); and
(d) apply a compiler-assisted DNN acceleration framework to the DNN model trained in (c) to generate code to be executed on the mobile device.

10. The computer system of claim 9, wherein (d) includes converting the DNN model trained in (c) into one or more computational graphs and performing one or more compiler optimizations based on the sparse convolution patterns for compressed DNN execution.

11. The computer system of claim 9, wherein the one or more optimizations are applicable to a CPU or a GPU of the mobile device.

12. The computer system of claim 9, wherein the one or more optimizations includes performing a high-level fine-grained Layerwise Representation (LR) to capture the sparsity information from (a) and (b).

13. The computer system of claim 9, wherein the one or more optimizations includes performing filter kernel reordering to organize filters with similar kernels of the DNN model together to improve inter-thread parallelization and order the same kernels in a filter together to improve intra-thread parallelization.

14. The computer system of claim 9, wherein the one or more optimizations includes storing weights of the DNN model in a compact format.

15. The computer system of claim 9, wherein the one or more optimizations includes performing load redundancy elimination in the DNN model.

16. The computer system of claim 9, wherein the one or more optimizations includes automatically tuning configuration parameters.

17. A computer program product for compressing a deep neural network (DNN) model by DNN weight pruning and accelerating DNN execution in a mobile device to achieve real-time inference, said computer program product residing on a non-transitory computer readable medium having a plurality of instructions stored thereon which, when executed by a computer processor, cause that computer processor to: (a) perform an intra-convolution kernel pruning of the DNN model wherein a fixed number of weights are pruned in each convolution kernel of the DNN model to generate sparse convolution patterns; (b) perform inter-convolution kernel pruning of the DNN model to generate connectivity sparsity, wherein inter-convolution kernel pruning comprises cutting connections between given input and output channels of the DNN model to remove corresponding kernels; (c) train the DNN model compressed in (a) and (b); and (d) apply a compiler-assisted DNN acceleration framework to the DNN model trained in (c) to generate code to be executed on the mobile device.

18. The computer program product of claim 17, wherein (d) includes converting the DNN model trained in (c) into one or more computational graphs and performing one or more compiler optimizations based on the sparse convolution patterns for compressed DNN execution.

19. The computer program product of claim 17, wherein the one or more optimizations includes performing a high-level fine-grained Layerwise Representation (LR) to capture the sparsity information from (a) and (b).

20. The computer program product of claim 17, wherein the one or more optimizations includes performing filter kernel reordering to organize filters with similar kernels of the DNN model together to improve inter-thread parallelization and order the same kernels in a filter together to improve intra-thread parallelization.
